(19) United States
(12) Patent Application Publication
(10) Pub. No.: US 2026/0049890 A1
(43) Pub. Date: Feb. 19, 2026

(54) SYSTEM AND METHOD FOR ASSESSING SEISMIC RESILIENCE OF DETERIORATED RAILWAY INFRASTRUCTURE

(71) Applicant: KOREA RAILROAD RESEARCH INSTITUTE, Uiwang-si (KR)

(72) Inventors: Tae Hoon KIM, Seongnam-si (KR); Choon Seok BANG, Yongin-si (KR); Yun Suk KANG, Yongin-si (KR); Lee Hyeon KIM, Seoul (KR)

(21) Appl. No.: 19/278,366

(22) Filed: Jul. 23, 2025

(30) Foreign Application Priority Data
Aug. 13, 2024 (KR) 10-2024-0108130

(51) Int. Cl. G01M 5/00; G06Q 50/26

(52) U.S. Cl. CPC G01M 5/0066; G06Q 50/265

(57) ABSTRACT

Described are a system and method for assessing seismic resilience of deteriorated railway infrastructure that can assess seismic resilience of railway infrastructure by quantifying resilience according to disaster safety by reflecting a resilience concept of an urban network type and extending to a damage index-based seismic performance assessment based on the quantified resilience, in railway infrastructure such as deteriorated concrete bridges, tunnel structures, and concrete slab tracks, define a correlation between a seismic performance value of deteriorated railway infrastructure and resilience of an urban network by calculating a reliable damage index, quantify and calculate resilience of detailed facilities of the urban network, and link the quantified and calculated resilience with the seismic performance value of the railway infrastructure to calculate a final seismic resilience of the urban network, and furthermore, easily assess resilience of the entire urban network as well as seismic performance/resilience of aged railway infrastructure.

### CROSS-REFERENCE TO RELATED APPLICATIONS

This application claims the priority of Korean Patent Application No. 10-2024-0108130 filed on Aug. 13, 2024, in the Korean Intellectual Property Office, the disclosure of which is incorporated herein by reference.

### BACKGROUND

### Field

The present disclosure relates to a system for assessing seismic resilience, and more particularly, to a system and method for assessing seismic resilience of deteriorated railway infrastructure by quantifying resilience according to disaster safety in railway infrastructure, such as deteriorated concrete bridges, tunnel structures, and concrete slab tracks, and extending to damage index-based seismic performance assessment to assess seismic resilience of railway infrastructure.

### Description of the Related Art

Due to recent earthquakes occurring worldwide, damage to social infrastructure such as buildings and bridges has been increasing. Among these, damage or collapse of bridge structures may lead to catastrophic losses in modern society.

In particular, among the components of bridges, which serve a critical role as infrastructure, piers are highly vulnerable to earthquake loads. As a result, a review of the seismic performance of the piers constructed in the past without seismic design regulations is required.

There is growing interest in cost-effective measures to improve the performance of piers through retrofitting, rather than fully replacing piers that were not seismically designed, in order to meet current seismic design regulations.

Therefore, studies to accurately assess the seismic performance of the existing pier structures and to improve the seismic performance of the pier structures accordingly are an urgent issue.

Meanwhile, according to the report “Development of Decision-Making Technology for Seismic Performance Management of Aging Road Facilities by Quantifying Urban Earthquake Resilience” published in 2016, it suggests that the paradigm in the field of disaster safety regarding earthquake disasters is changing.

Specifically, traditional disaster management focused on post-disaster recovery, but it is increasingly shifting toward a prevention-centered disaster management framework. The change in the disaster management paradigm is due to the emergence of unpredictable risk factors across society and the rapid increase in secondary, non-natural, man-made, and uncertain structured risks.

The change in the prevention-centered disaster management may be a change from the conventional concept of recovery to the extended concept of resilience.

Here, the resilience refers to the capacity to overcome external shocks or adversities through intrinsic power and recover previous functions. In the field of the disaster management (or hazard management), it suggests that active efforts are being made to introduce the resilience concept to develop advanced decision-making systems for disaster prevention.

Meanwhile, according to the report titled “Study on Establishing a System for Diagnosing and Managing Seismic Level of Aging Infrastructure” published in 2019, the large-scale growth, networking, and strengthening interdependence of cities show a transition into complex systems, and it is expected that the complexity will accelerate as the proportion of people living in urban areas continues to increase.

FIG. 1 is a diagram illustrating a transition from recovery on an individual facility basis to resilience from a network perspective.

As illustrated in FIG. 1, the existing risk management system that focuses on loss prediction and prevention or post-recovery on an individual facility basis has limitations. Thus, the resilience concept, which manages disaster risks from a whole-system perspective and a network-based perspective that manages risks throughout the entire cycle, is emerging as a future paradigm for disaster and hazard management.

Specifically, the network perspective refers to facilities necessary for operating large cities and local communities, such as roads, gas, water and sewage, electricity, and communications, and network connections that connect the facilities. Disasters such as earthquakes directly damage individual structures, such as bridges, roads, and concrete structures for railways (tunnels, concrete tracks, and track structures other than bridges for railways), which means indirectly damaging the network system.

Meanwhile, according to the “Definition and Quantification of System Resilience” data published in 2022, in order to reduce disaster damage, appropriate prevention and preparedness as well as efficient recovery and response, are necessary. In this case, it specifies that a quantitative assessment of resilience at a system level is essential.

In particular, it suggests the necessity of developing an assessment technology for the physical resilience of networks that may probabilistically assess the degradation in network performance due to the occurrence of earthquake and the recovery of performance through resilience, by considering the physical vulnerability and the degree of aging of individual facilities (bridges, roads, and concrete structures for railways (bridges, tunnels, concrete slab tracks, and tracks for railways)) that constitute the network, in order to enable resilience-based decision-making from a network perspective in the event of an earthquake.

Meanwhile, academia-industry collaborative research is being conducted on the technology for assessing the degradation of network seismic performance considering the degree of aging and assessing resilience, as described below.

FIG. 2 is a diagram illustrating the definition and quantification of the system resilience.

As illustrated in FIG. 2, the technology for analyzing the damage level of each major component of road facilities and quantifying earthquake behavior of road facilities based on aging is being developed, and a probabilistic assessment technology for network resilience that takes into account the aging of facilities is also being developed.

Meanwhile, the report on “Evaluation of Seismic Damage for Reinforced Concrete Bridge Piers” discloses a method for evaluating seismic performance of bridges, and introduces a method for quantitatively evaluating a degree of damage to a structure using nonlinear finite element analysis that can calculate a damage index for a dynamic behavior of a structure under earthquake loads.

For example, Reinforced Concrete Analysis in Higher Evaluation System Technology (RCAHEST) may predict fatigue behavior according to cyclic loads and calculate a damage index to simulate an actual behavior of a structure, which is a multi-degree-of-freedom system, through the finite element analysis.

Specifically, the method of calculating a damage index is based on a failure criterion based on an ultimate strain of concrete and rebar obtained by nonlinear analysis, in which the failure criterion calculates the damage index corresponding to the strain of each finite element analysis step based on the compressive failure and shear failure of concrete and the tensile failure of rebar, and is configured to be expressed from 0.0, which is no damage, to 1.0, which indicates failure.

Meanwhile, as an extended study on damage index, ┌Seismic Performance Assessment of Hollow Reinforced Concrete Bridge Columns using an Extended Damage Index┘ discloses a method for predicting seismic performance by quantifying damage to a pier through an extended damage index by newly establishing an analysis technique and model for assessing the seismic performance of a hollow reinforced concrete pier, which is a conventional damage index calculation target.

In other words, the nonlinear behavior characteristics and earthquake damage performance of both solid and hollow reinforced concrete piers, which contribute to their overall seismic performance, may be reliably assessed through a nonlinear finite element analysis program that calculates the quantitative damage index.

Meanwhile, looking at the report on “Probabilistic Seismic Performance Evaluation of Open-Cut Tunnels for Subway Systems,” among open-cut tunnels, bridges, and stations (building structures) which are the main structures of urban railways, based on the study of earthquake engineering perspectives on the open-cut tunnels, by identifying dynamic characteristics of the ground affected by a ground layer from a bedrock to a ground surface due to an earthquake, and approaching the uncertainty factors inherent in the dynamic characteristics of the ground due to natural/artificial reasons in the construction of the structure in a statistical probability manner, the seismic performance evaluation is conducted on the railway open-cut tunnels which are underground structures.

Specifically, the effects of uncertain dynamic properties of the ground on the seismic performance of the open-cut tunnels are identified, and the seismic performance is evaluated by the probabilistic method, but, and the First-Order Second-Moment (FOSM) method is used to assume the dynamic properties of the ground used for the seismic performance evaluation of the open-cut tunnels as probability variables and ensure that these probability variables may be propagated through the seismic performance evaluation procedure so that the finally calculated values may also be evaluated as the probability variables. The applicability and effectiveness of the FOSM method are verified by applying it to the open-cut tunnels in domestic urban railway systems.

Meanwhile, looking at the report on “Fracture Behavior of Dowel Joint of Concrete Slab Track,” a nonlinear finite element analysis model is presented based on a connection shear spring element that may effectively idealize bearing stiffness and clearance of a dowel joint to predict the shear behavior of the dowel joint, in a dowel bar joint configuration used in the connection of the concrete slab track.

In addition, in order to verify the validity of the analysis model, a loading test was conducted to analyze the failure behavior and ultimate load of slab tracks. This enables the prediction of nonlinear behavior up to the failure of concrete pavement and concrete track, presenting the contents used in the design of the concrete track.

Accordingly, it can be seen that various methods are being studied to evaluate the seismic stability of bridges, tunnels, and concrete slab tracks in relation to railway concrete structures, through failure behavior, load analysis, etc.

In the end, according to the conventional technology, the large-scale growth, networking, and strengthening interdependence of cities show a transition into complex systems, and the complexity will accelerate as the proportion of people living in urban areas continues to increase. In the event of disasters such as an earthquake, from a networked perspective, loss on an individual facility basis inevitably causes damage to the entire system.

Accordingly, there is a need for research and development on a disaster risk management system based on the resilience concept, which manages disaster risks throughout the entire cycle from the entire system perspective.

More specifically, in order to enable disaster management decision-making based on resilience, quantitative resilience assessment technology is required to assess the degradation in network performance due to the occurrence of earthquake and the recovery through resilience, taking into account the physical vulnerability and the degree of aging of individual facilities that constitutes the network, and various studies are being conducted on this quantitative resilience assessment technology.

Meanwhile, as a method for assessing seismic performance of a bridge among individual facilities, a method for quantitatively assessing the degree of damage to structures using nonlinear finite element analysis capable of calculating a damage index to analyze dynamic behavior under earthquake loads is disclosed. A method for reliably assessing seismic performance of reinforced concrete piers of hollow structures as well as solid structures by expanding an assessment target through a nonlinear finite element analysis program that calculates a damage index in quantitative values has been studied.

In addition, a method for assessing seismic performance of a railway open-cut tunnel by using an FOSM method that assumes dynamic properties of the ground used for assessing seismic performance of a open-cut tunnel, which are railway structures excluding bridges, as probability variables, and propagates these probability variables through a seismic performance assessment procedure so that finally calculated values may be assessed as the probability variables has been studied.

Therefore, in relation to the track structure, a study has been conducted on the nonlinear behavior up to the failure of the concrete pavement and concrete track by analyzing the fracture behavior and ultimate load of the slab track in the dowel bar joint configuration used in the connection of the concrete slab track.

In addition, the contents are reviewed based on the perspective of the seismic performance and seismic resilience assessment technology of aged concrete bridges and railway concrete structures to which the disaster management of the resilience concept is reflected and the damage index is applied.

Meanwhile, as the prior art related to resilience for urban regeneration, the invention entitled “Urban regeneration information system” is disclosed in Korean Patent No. 10-1375441, which discloses calculating, as indicators, the degree of imbalance in economic, social, cultural, and service aspects, as well as the aging/decline phenomenon of physical infrastructure within each city, and establishing a comprehensive urban regeneration strategy by taking into account the commonalities and differences among cities, which will be described with reference to FIG. 3.

FIG. 3 is a configuration diagram of an urban regeneration comprehensive information system according to the conventional technology.

Referring to FIG. 3, the urban regeneration comprehensive information system according to the conventional technology is configured to include a system 10 for diagnosing a decline degree at a reference time point, a period-specific decline diagnosis system 20, and a potential diagnosis system 30.

The system 10 for diagnosing a decline degree at a reference time point is configured to include an individual decline indicator setting unit 11, an individual decline indicator standardization unit 12, an individual decline indicator calculation unit 13, and a spatial decline calculation unit 14.

Accordingly, the system 10 for diagnosing a decline degree at a reference time point sets decline indicator items that may determine the degree of physical aging, the degree of economic decline, and the degree of demographic and social decline in order to determine the degree of decline of each region, and when the indicator values corresponding to each set decline indicator are input, calculates decline indices for each decline indicator, and then adds up a plurality of decline indices to calculate a decline degree at a reference time point, which is a decline grade for relatively determining the extent to which a specific region is declined compared to other regions.

The period-specific decline diagnosis system 20 includes an annual indicator storage unit 21, a change rate calculation unit 22, a change rate standardization unit 23, and a period-specific decline degree calculation unit 24, and the period-specific decline degree calculation unit 24 may include a standard score summation unit 24a, a weighted summation unit 24b, and a decline grade calculation unit 24c.

Accordingly, the period-specific decline diagnosis system 20 stores the indicator values of the decline indicators stored in the system for diagnosing a decline degree at a reference time point for each regular period, calculates a change rate of each decline indicator during the regular periods to calculate the period-specific decline index for each region, which represents the decline degree over time, and then calculates the period-specific decline degree which is a decline grade to determine the extent to which the same region has declined over time.

The potential diagnosis system 30 includes a potential indicator setting unit 31, a potential indicator value standardization unit 32, and a potential grade calculation unit 33.

Accordingly, the potential diagnosis system 30 sets potential indicator items to determine the potential of a city that may improve the decline degree at a reference time point and the period-specific decline degree through the urban regeneration, calculates potential indices for each potential indicator when the indicator values corresponding to each set potential indicator are input, and then calculates a potential grade by adding theses indices to indicate the extent to which improvement may be achieved through urban regeneration.

According to the comprehensive urban regeneration information system based on conventional technology, in order to solve the decline problem of community and realize the urban regeneration, the decline degree at a reference time point, which indicates the extent to which the region has declined compared to other regions is diagnosed by setting a number of decline indicators to objectively evaluate the decline degree in each region, and then comparing the indicator values of the decline indicators with the indicator values of other regions at the same time point, and a period-specific decline degree, which indicates how much the same region has declined over time, is diagnosed by calculating the change rate over time for the indicator values of each decline indicator that is stored at regular periods, thereby determining the decline grades of each region considering the decline degree at the reference time point and the period-specific decline degree may be determined and using the decline grades as basic data for urban regeneration.

Meanwhile, as another prior art, Korean Patent No. 10-2041515 discloses an invention entitled “Analysis model construction method for evaluating seismic safety of bridge, and analysis model construction system,” which discloses constructing an analysis model by analyzing a structure of a bridge according to a finite element analysis method and constructing an analysis model by combining node data indicating a three-dimensional spatial position, material data (nonlinear characteristics), cross-section data, element data, boundary condition data, and load condition data, which will be described with reference to FIG. 4.

FIG. 4 is a diagram for describing a concept of a structure damage evaluation system according to the conventional technology.

Referring to FIG. 4, the structure damage evaluation system according to the conventional technology largely includes an acceleration sensor device 40 that is installed in a structure such as a building or a factory, and a damage evaluation server 50 that evaluates damage to a structure by using structure vibration information from the acceleration sensor device 40.

The acceleration sensor device 40 is installed on the ceiling and ground of the structure, and has a function of generating structural vibration information in the event of disasters such as the occurrence of earthquake. In particular, as illustrated, the acceleration sensor may be configured to include a first sub-acceleration sensor 41 installed on the ceiling, and a second sub-acceleration sensor 42 installed on the ground to be vertically spaced apart from the first sub-acceleration sensor 41, and thus, may be configured to transmit the first and second sub-structure vibration information together to the damage evaluation server 50.

The damage evaluation server 50 has a function of evaluating the damage to the structure by using the structure vibration information from the acceleration sensor device 40 and the structure information and safety information stored in the internal memory.

In addition, the damage evaluation server 50 performs noise filtering on raw structure vibration information, and then obtains optimal structure vibration information through various other corrections and analyzes this optimal structure vibration information, thereby obtaining the damage to the structure, earthquake information, or natural frequency information of the structure.

According to the structure damage evaluation system according to the conventional technology, by attaching the acceleration sensor to the structure and analyzing the vibration information obtained therefrom, the damage to the structure may be quickly and accurately calculated, thereby preventing disasters such as structure collapse in advance.

Meanwhile, as another prior art, Korean Patent No. 10-1750281 discloses an invention entitled “Method for evaluating damage of structure, and structure damage evaluation system,” which discloses integrating acceleration for vibration information to obtain maximum displacement information, applying the maximum displacement information to a nonlinear load-displacement curve included in the frame information to obtain structure limit information, and then obtaining structure damage information according to the structure limit information and the maximum displacement information, which will be described with reference to FIGS. 5A and 5B.

FIG. 5A is a configuration diagram of an analysis model construction system for evaluating seismic safety of a bridge according to the conventional technology, and FIG. 5B is a configuration diagram of an analysis model construction system according to the conventional technology.

Referring to FIG. 5A, an analysis model construction system 60 for evaluating seismic safety of a bridge according to the conventional technology may include a processing unit 61, an output unit 62, a database 63, and an evaluation unit 64.

When a request for evaluating seismic safety of a bridge due to the occurrence of earthquake is received, the processing unit 61 uses the earthquake input to the bridge to generate state data on the structure of the bridge after the occurrence of earthquake.

Specifically, the processing unit 61 analyzes the structure of the bridge according to the finite element analysis method to construct the analysis model, maintains the analysis model in the database 63 in association with the model information of the bridge, and applies the input earthquake to the analysis model searched from the database 63 according to the model information of the bridge to which the input earthquake is input to generate the state data.

For example, the processing unit 61 may determine a structure composed of nodes, elements, constraints, and boundary conditions to analyze the bridge according to the finite element analysis method, and construct the analysis model as illustrated in FIG. 5B, including load conditions for loads and load cases to be applied to the structure and a method for analyzing loads applied to a structure.

The output unit 62 combines the state data to constitute a seismic analysis file for the bridge, and outputs the seismic analysis file as a response to the evaluation request.

The evaluation unit 64 identifies a safety range selected for the bridge from the result report conditions searched from the database 63 together with the analysis model, and evaluates the safety of the bridge by determining whether at least one of the state data of the load change, stress change, and deformation of the bridge, which constitute the seismic analysis file, is out of the safety range.

In relation to constructing this analysis model, as illustrated in FIG. 5B, an analysis model construction system 70 may include a finite element analysis model database 71, an input earthquake data database 72, and a finite element analysis model calculation program 73.

The finite element analysis model database 71 maintains an analysis model constructed by dynamically analyzing a structure of an individual bridge based on the finite element analysis method.

For example, the finite element analysis model database 71 may maintain an analysis model of an individual bridge, including general bridge data required to determine a structure of simulation of an individual bridge, boundary condition data required to determine an application location of the input earthquake, load condition data regarding loads acting on the bridge according to the size of the input earthquake, and configuration data analyzing the deformation occurring in materials, cross-sections, nodes, and elements of the bridge according to the size of the input earthquake.

The input earthquake data database 72 maintains data regarding the earthquake input to the bridge when an earthquake occurs. That is, the input earthquake data database 72 may obtain earthquake acceleration information of the input earthquake from a meteorological agency server, maintain the earthquake acceleration information in the form of seismic time history data, or maintain the earthquake acceleration information by processing the earthquake acceleration information in a frequency domain.

The finite element analysis model calculation program 73 performs a seismic review of the bridge by using the analysis model constructed for the bridge and the input earthquake input to the bridge in conjunction with the finite element analysis model database 71 and the input earthquake data database 72 when an earthquake occurs.

According to the analysis model construction system for evaluating seismic safety of a bridge according to the conventional technology, the seismic safety of each of a plurality of bridges installed widely may be quickly confirmed when an earthquake occurs by using the analysis model constructed by dynamically analyzing the structure of each bridge based on the finite element analysis method.

In addition, the analysis model for analyzing the structure of individual bridges may be databased, and only the changes detected in the bridges may be simply updated, so the seismic safety of the bridges may be evaluated more accurately.

In addition, by constructing an analysis model for evaluating the seismic safety of arbitrary bridges distributed over a wide area according to the finite element analysis method, the seismic safety may be quickly evaluated when the earthquake occurs, and by individually changing, modifying, and recombining the bridge information, the analysis method, and the result output method for the finite element analysis, there is no need to modify the entire bridge information, and the work time of engineering technicians may be reduced.

As described above, the large-scale growth, networking, and strengthening interdependence of cities show a transition into complex systems, and the complexity will accelerate as the proportion of people living in urban areas continues to increase. In the event of disasters such as an earthquake, from a networked perspective, loss on an individual facility basis inevitably causes damage to the entire system. As a result, there is a need for research and development of a disaster risk management system based on the resilience concept, which manages disaster risks from a whole-system perspective across their entire cycle.

However, the specific seismic stability assessment configuration of the railway infrastructure reflecting the concept of overall network resilience has not been disclosed.

Therefore, since earthquake vulnerability is increasing due to the increase in deteriorated railway infrastructure due to aging, etc., a technology capable of preventing potential safety accidents and social/economic damage caused by deteriorated railway infrastructure due to aging, etc., based on seismic resilience quantification is needed.

In particular, a technology for assessing seismic resilience of deteriorated railway infrastructure due to aging, etc., that reflects a change in disaster safety paradigm of the new resilience concept is needed.

The background technology of this application is as follows.

Patent Documents that serve as the background of this application are as follows: (Patent Document 0001) Korean Patent No. 10-1375441 (Registration Date: Mar. 11, 2014), the title of the invention: “Urban regeneration information system,” (Patent Document 0002) Korean Patent No. 10-2041515 (Registration Date: Oct. 31, 2019), the title of the invention: “Analysis model construction method for evaluating seismic safety of bridge, and analysis model construction system,” (Patent Document 0003) Korean Patent No. 10-2124062 (Registration Date: Jun. 11, 2020), the title of the invention: “System for evaluating deteriorated level of facility,” (Patent Document 0004) Korean Patent No. 10-1750281 (Registration Date: Jun. 19, 2017), the title of the invention: “Method for evaluating damage of structure, and structure damage evaluation system,” (Patent Document 0005) Korean Patent No. 10-1903879 (Registration Date: Sep. 21, 2018), the title of the invention: “Device and method for seismic safety estimation for infrastructures,” (Patent Document 0006) Korean Patent Laid-Open Publication No. 2016-010797 (Publication Date: Jan. 28, 2016), the title of the invention “A method for evaluating resilience cost index.”

Next, the non-patent document which is the background of this application is (Non-patent Document 0001) Journal of the Korea Concrete Institute, Vol. 30, No. 2, pp. 167 to 177, April 2018, Tae-Hoon Kim, Title of the paper: “Seismic Performance Assessment of Hollow Reinforced Concrete Bridge Columns using an Extended Damage Index,” (Non-patent Document 0002) Journal of the Korean Society of Civil Engineers, Structural Engineering, Vol. 25, No. 3A, May 2005, pp. 565 to 575, Title of the paper: “Analytical study on the seismic performance of reinforced concrete pier.”

### SUMMARY

An object of the present disclosure is to provide a system and method for assessing seismic resilience of deteriorated railway infrastructure, which may assess seismic resilience of railway infrastructure by quantifying resilience according to disaster safety by reflecting a resilience concept of an urban network type and extending to a damage index-based seismic performance assessment based on the quantified resilience, in railway infrastructure such as deteriorated concrete bridges, tunnel structures, and concrete slab tracks.

Another object of the present disclosure is to provide a system and method for assessing seismic resilience of deteriorated railway infrastructure, which may define a correlation between a seismic performance value of deteriorated railway infrastructure and resilience of an urban network by calculating a reliable damage index, quantify and calculate resilience of detailed facilities of the urban network, and link the quantified and calculated resilience with the seismic performance value of the railway infrastructure to calculate a final seismic resilience of the urban network.

Still another object of the present disclosure is to provide a system and method for assessing seismic resilience of deteriorated railway infrastructure, which may assess resilience of the entire urban network as well as seismic performance/resilience of aged railway infrastructure by linking with a seismic performance value calculated based on a damage index to enable individual resilience calculation of the deteriorated railway infrastructure, and at the same time, deriving comprehensive calculation values for resilience such as a resilience amount, a resilience speed, and resilience cost of the entire urban network.

In the present disclosure, a system for assessing seismic resilience of deteriorated railway infrastructure according to the present disclosure includes: a disaster/hazard resilience management unit that collects external data from an external data providing unit providing external data for the deteriorated railway infrastructure, which is a target of seismic resilience assessment, to calculate the resilience, performs resilience assessment by urban regeneration in response to a degree of aging of the railway infrastructure, and assesses recovery activities of the urban network; a damage index-based seismic performance assessment unit that calculates a damage index and assesses seismic performance of the railway infrastructure; and a seismic resilience assessment unit that defines a correlation between the damage index-based seismic performance and resilience of the urban network, calculates resilience quantification for detailed facilities of the urban network, and calculates the seismic resilience of the deteriorated railway infrastructure by linking the calculated seismic resilience with the calculated seismic performance value, in which the seismic performance of the damage index-based railway infrastructure is assessed in response to a resilience quantification calculation value from a urban network perspective by the disaster/hazard resilience management unit.

Here, the deteriorated railway infrastructure may be selected from a concrete bridge, a tunnel structure, or a concrete slab track.

Here, the disaster/hazard resilience management unit may include: a resilience calculation module that calculates standardized values using climate change data, construction information and GIS data, and population/residential/industrial-based statistics, calculates a vulnerability index of an administrative district, and calculates resilience based on a capacity index; a resilience assessment module that sets multiple decline indicators that assess a decline degree of each assessment region, diagnoses a period-specific decline degree that indicates the degree of aging by calculating a change rate over time for each decline indicator value stored at regular periods, and assesses potential by urban regeneration; and a recovery activity assessment module that obtains disaster data for each assessment region, calculates a disaster prevention cost index of the assessment region using the disaster data, and assesses recovery activities by observing a temporal trend of the disaster prevention cost index between the assessment regions.

Here, the damage index-based seismic performance assessment unit may include: a bridge seismic performance assessment module that assesses seismic performance of a concrete bridge with the damage index reflected according to a finite element analysis method, when the railway infrastructure is the concrete bridge; a tunnel structure seismic performance assessment module that assesses seismic performance of a tunnel structure with the damage index reflected by extracting a ground response spectrum, when the railway infrastructure is the tunnel structure; and a concrete slab track seismic performance assessment module that assesses seismic performance of a concrete slab track with the damage index reflected according to a possibility of deflection of the concrete slab track, when the railway infrastructure is the concrete slab track.

Here, the seismic resilience assessment unit may include: a correlation definition module that defines a correlation between a seismic performance value of the deteriorated railway infrastructure and the resilience of the urban network calculated by the disaster/hazard resilience management unit according to the damage index calculated by the damage index-based seismic performance assessment unit; a resilience quantification calculation module that quantifies and calculates the resilience of each detailed facility of the urban network based on the defined correlation; and a seismic resilience calculation unit that calculates a seismic resilience value of the urban network by linking the quantified and calculated resilience with the seismic performance value of the deteriorated railway infrastructure.

In the present disclosure, a method for assessing seismic resilience of deteriorated railway infrastructure according to the present disclosure includes: a) collecting, by a disaster/hazard resilience management unit, external data to calculate resilience for the deteriorated railway infrastructure that is a target of a seismic resilience assessment; b) performing, by the disaster/hazard resilience management unit, resilience assessment by urban regeneration in response to a degree of aging of the railway infrastructure; c) assessing, by the disaster/hazard resilience management unit, recovery activities of an urban network; d) assessing, by a damage index-based seismic performance assessment unit, seismic performance for railway infrastructure according to an extended damage index; e) defining, by a seismic resilience assessment unit, a correlation between a damage index-based seismic performance value and the resilience of the urban network; f) calculating, by the seismic resilience assessment unit, resilience quantification for detailed facilities of the urban network; and g) calculating the seismic resilience of the deteriorated railway infrastructure by linking with the seismic performance value calculated by the seismic resilience assessment unit, in which the seismic performance of the damage index-based railway infrastructure is assessed in response to a resilience quantification calculation value from the urban network perspective by the disaster/hazard resilience management unit.

According to the present disclosure, in the railway infrastructure such as the deteriorated concrete bridges, the tunnel structures, the concrete slab tracks, etc., it is possible to assess the seismic resilience of the railway infrastructure by quantifying the resilience according to the disaster safety by reflecting the resilience concept of the urban network type, and extending to the damage index-based seismic performance assessment according to the quantified resilience.

According to the present disclosure, by calculating the reliable damage index, it is possible to define the correlation between the seismic performance value of the deteriorated railway infrastructure and the resilience of the urban network, and by quantifying and calculating the resilience of the detailed facilities of the urban network and by linking the quantified and calculated resilience with the seismic performance value of the railway infrastructure, it is possible to quickly calculate the final seismic resilience of the urban network.

According to the present disclosure, by calculating the individual resilience of the aged railway infrastructure by linking the individual resilience with the seismic performance value calculated based on the damage index, and at the same time, by deriving comprehensive calculation values for resilience such as the resilience amount, resilience speed, and resilience cost of the entire urban network, it is possible to easily assess the resilience of the entire urban network as well as the seismic performance/resilience of aged railway infrastructure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a transition from recovery on an individual facility basis to resilience from a network perspective;

FIG. 2 is a diagram illustrating definition and quantification of system resilience;

FIG. 3 is a configuration diagram of an urban regeneration comprehensive information system according to the conventional technology;

FIG. 4 is a diagram for describing a concept of a structure damage evaluation system according to the conventional technology;

FIG. 5A is a configuration diagram of an analysis model construction system for evaluating seismic safety of a bridge according to the conventional technology, and FIG. 5B is a configuration diagram of an analysis model construction system according to the conventional technology;

FIG. 6A is a diagram for describing a resilience quantification concept considering deterioration applied to a system for evaluating seismic resilience of deteriorated railway infrastructure according to an embodiment of the present disclosure;

FIG. 6B is a diagram for describing four dimensions, robustness, redundancy, rapidity, and resourcefulness, defined according to an occurrence time of resilience, input timing of recovery resources, and a source of resilience occurrence;

FIG. 7A is a diagram schematically describing seismic performance assessment using a damage index in the system for assessing seismic resilience of deteriorated railway infrastructure according to an embodiment of the present disclosure, FIG. 7B is a diagram in a table form exemplarily showing an extension to a seismic performance assessment technique using the damage index, and FIG. 7C is a diagram in a table form showing that the damage index is calculated as a compressive damage index (DI_{compressive}) and a tensile damage index (DIₜₑₙₛᵢₗₑ), respectively, by a failure criterion based on an ultimate strain of concrete and rebar obtained by nonlinear finite element analysis;

FIG. 8 is a schematic configuration diagram of the system for assessing seismic resilience of deteriorated railway infrastructure according to an embodiment of the present disclosure;

FIG. 9 is a specific configuration diagram of an external data providing unit and a disaster/hazard resilience management unit in the system for assessing seismic resilience of deteriorated railway infrastructure according to an embodiment of the present disclosure;

FIG. 10 is a specific configuration diagram of a damage index-based seismic performance assessment unit in the system for assessing seismic resilience of deteriorated railway infrastructure according to an embodiment of the present disclosure;

FIG. 11 is a specific configuration diagram of a seismic resilience assessment unit in the system for assessing seismic resilience of deteriorated railway infrastructure according to an embodiment of the present disclosure;

FIG. 12 is a flowchart illustrating a method for assessing seismic resilience of deteriorated railway infrastructure according to an embodiment of the present disclosure;

FIGS. 13A and 13B are diagrams illustrating examples of hollow reinforced concrete pier test specimens when the deteriorated railway infrastructure is a concrete bridge;

FIG. 13C is a diagram in table form showing material properties of the hollow reinforced concrete pier test specimen illustrated in FIGS. 13A and 13B;

FIGS. 14A and 14B are diagrams illustrating examples of a finite element model when the deteriorated railway infrastructure is the concrete bridge;

FIG. 15 is a diagram illustrating a load-displacement curve as an experimental and analysis result to which the finite element model illustrated in FIGS. 14A and 14B is applied;

FIG. 16 is a drawing illustrating damage index-based seismic performance assessment for a deteriorated hollow reinforced concrete pier test specimen;

FIG. 17A is a diagram illustrating a monotonic tensile test for rebar, and FIG. 17B is a diagram illustrating representative test data of the monotonic tensile test for the rebar;

FIG. 18 is a diagram illustrating an example of residual maximum elongation compared to mass loss as an experimental result considering a reduction in elongation performance of the deteriorated rebar; and

FIG. 19 is a diagram illustrating the damage index-based seismic performance assessment considering the reduction in the elongation of the deteriorated rebar for the hollow reinforced concrete pier test specimen.

### DETAILED DESCRIPTION OF THE EMBODIMENT

Hereinafter, exemplary embodiments of the present disclosure will be described in detail with reference to the accompanying drawings so that they can be easily practiced by those skilled in the art to which the present disclosure pertains. However, the present disclosure may be modified in various different ways and is not limited to the embodiments provided in the present description. In the accompanying drawings, portions unrelated to the description will be omitted in order to obviously describe the present disclosure, and similar reference numerals will be used to describe similar portions throughout the present specification.

Throughout the present specification, unless explicitly described to the contrary, “comprising” any components will be understood to imply the inclusion of other elements rather than the exclusion of any other elements. A term “ . . . unit”, or the like, described in the specification means a unit of processing at least one function or operation and may be implemented by hardware or software or a combination of hardware and software.

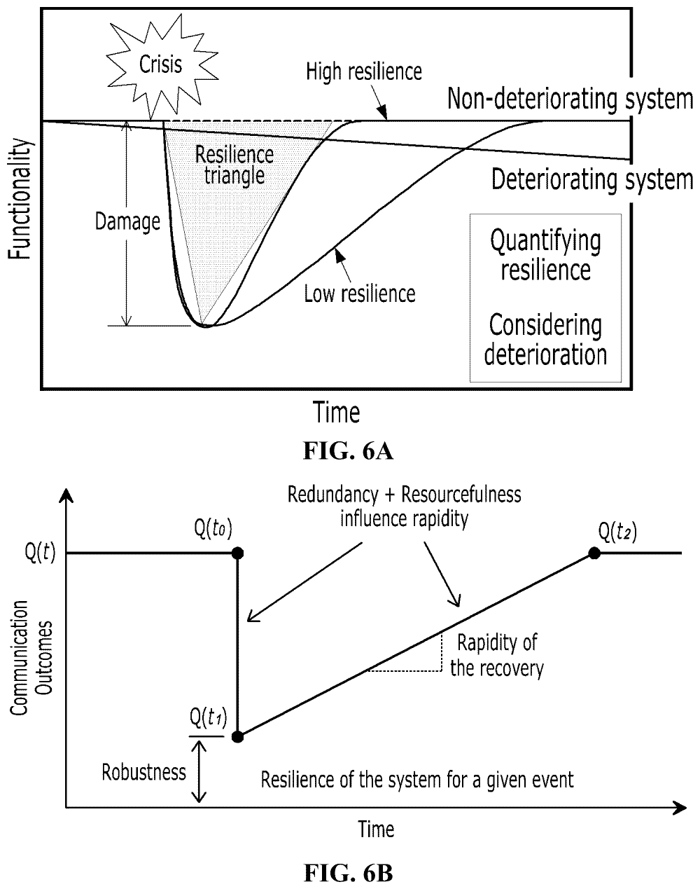

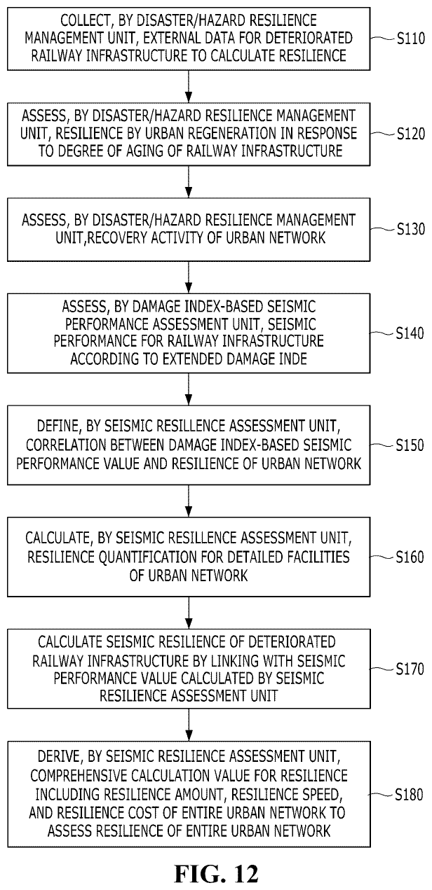

Hereinafter, a system for assessing seismic resilience of deteriorated railway infrastructure according to an embodiment of the present disclosure will be described with reference to FIGS. 6 to 11, and a method for assessing seismic resilience of deteriorated railway infrastructure according to an embodiment of the present disclosure will be described with reference to FIG. 12.

### [System for Assessing Seismic Resilience of Deteriorated Railway Infrastructure]

FIG. 6A is a diagram for describing a resilience quantification concept considering deterioration applied to a system for assessing seismic resilience of deteriorated railway infrastructure according to an embodiment of the present disclosure. In addition, FIG. 6B is a diagram for describing four dimensions, robustness, redundancy, rapidity, and resourcefulness, defined according to an occurrence time of resilience, input timing of recovery resources, and a source of resilience occurrence.

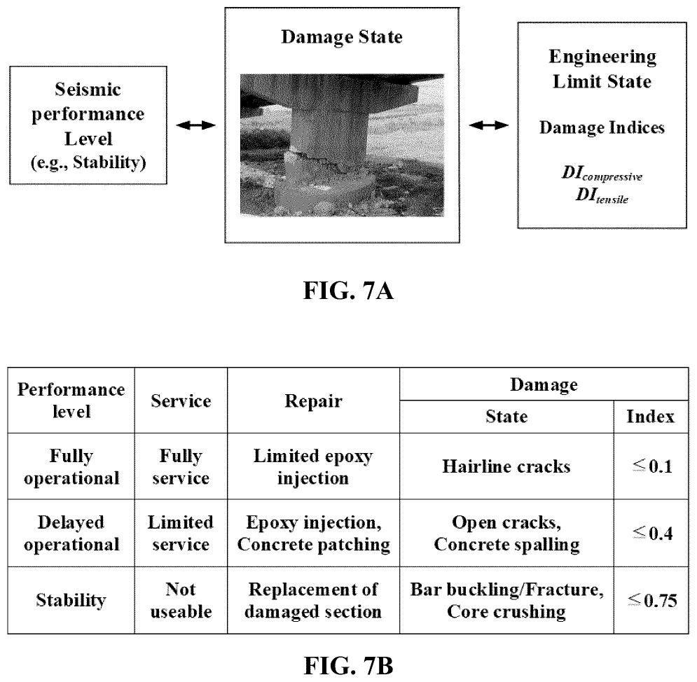

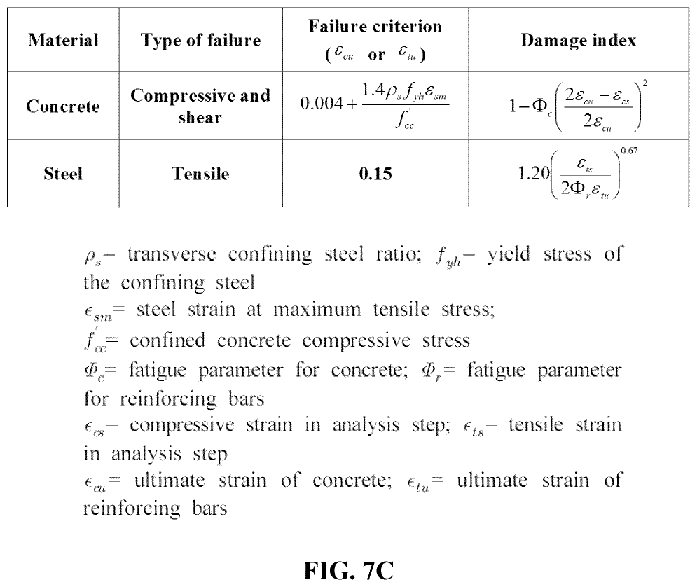

FIG. 7A is a diagram schematically describing seismic performance assessment using a damage index in the system for assessing seismic resilience of deteriorated railway infrastructure according to an embodiment of the present disclosure.

First, the resilience quantification concept considering deterioration due to aging, etc., is as illustrated in FIG. 6A, and in response to the increased earthquake vulnerability due to the increasing deterioration of railway infrastructure such as aging, etc., potential safety accidents and social/economic damages caused by the deteriorated railway infrastructure may be prevented through seismic resilience quantification.

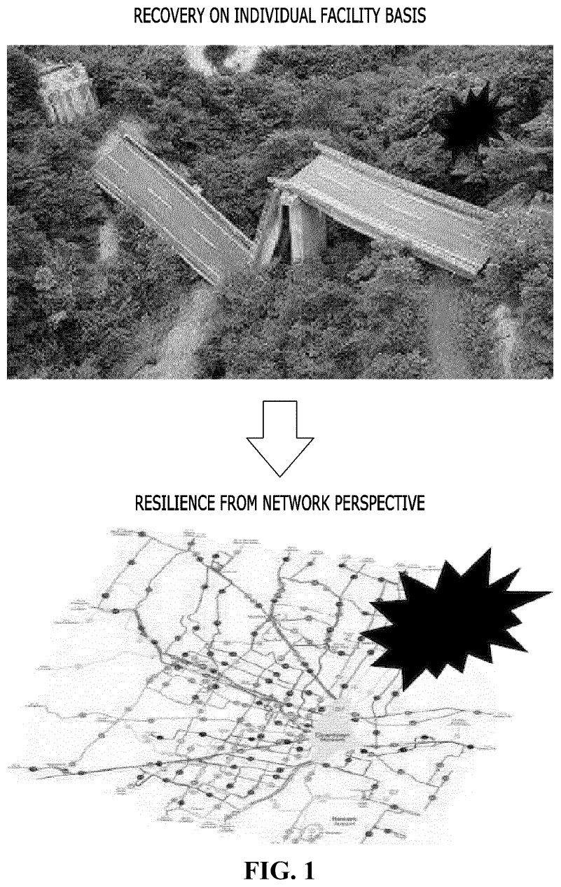

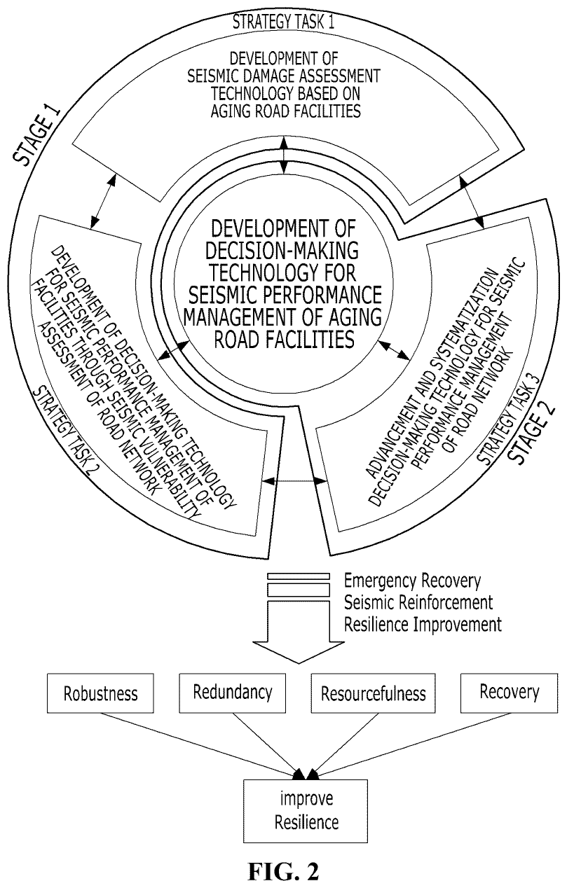

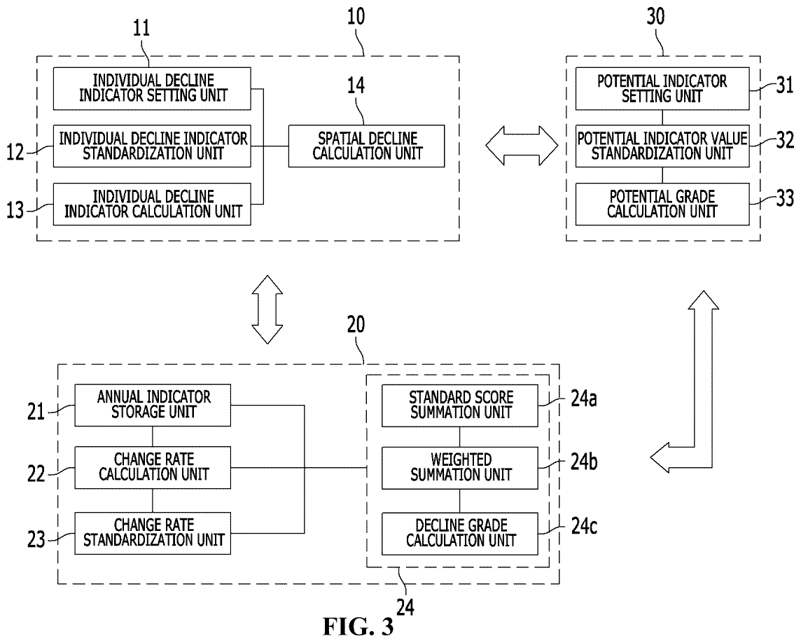

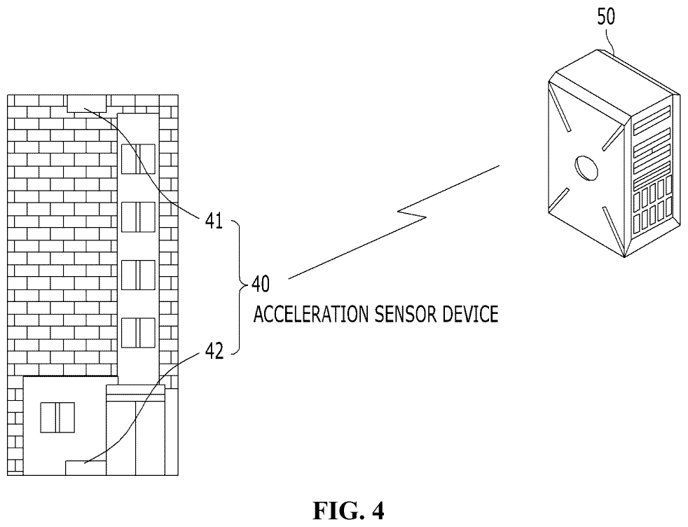

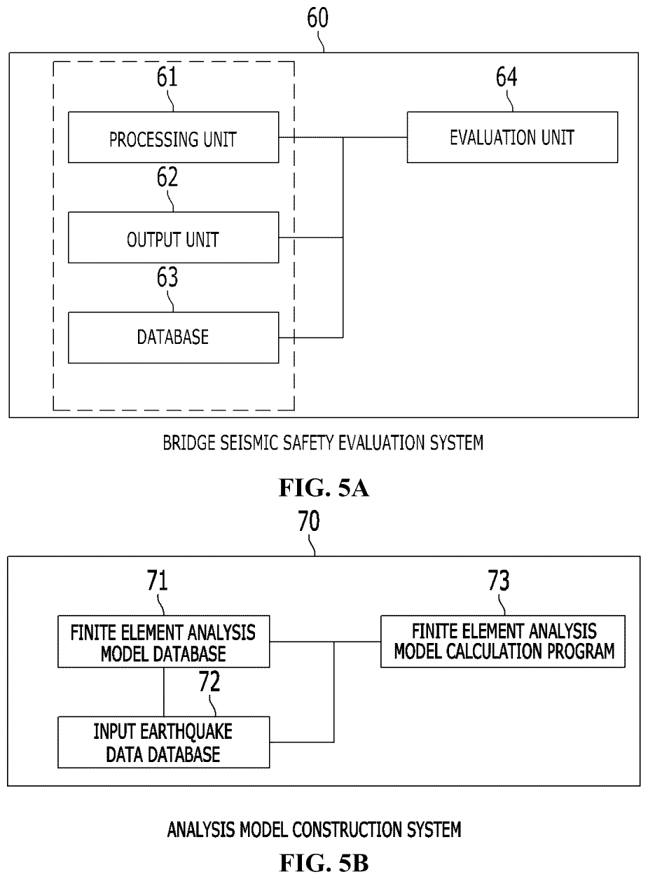

For example, an area of a resilience triangle plotted by functionality on Y-axis and time on X-axis in FIG. 6A means resilience loss, and the resilience loss may be calculated through integration as in the equation proposed by BRUNEAU et al. (2004), “A framework to quantitatively assess and enhance the seismic resilience of communities.” More specifically, BRUNEAU et al. (2004) proposed the resilience loss R in the form of an integral equation based on FIG. 1 illustrated in BRUNEAU et al. (2004). For reference, in the integral equation based on FIG. 1 illustrated in BRUNEAU et al. (2004), t₀ denotes the time when a disaster/hazard such as an earthquake occurs, t₁ denotes the time to complete recovery, and Q(t) denotes the quality of infrastructure that varies over time (corresponding to functionality in FIG. 6A). Since this may be understood through matters described in BRUNEAU et al. (2004), a more detailed description thereof will be omitted.

Defining each of the four dimensions with reference to FIG. 6B, the robustness is the ability of the system to withstand a disaster without a serious decrease in performance, and may be defined as the ability that may be ensured when each element maintains its original function. In addition, the redundancy is the ability to replace the original function by securing sufficient spare capacity, and may be the ability that may be ensured by having alternative infrastructure, surplus resources, and a variety of financial, economic, and communication means. In addition, the rapidity may be defined as the ability to quickly and efficiently achieve goals and recover the original function while satisfying priorities, suppressing losses, and avoiding confusion. In addition, the resourcefulness may be defined as the ability to diagnose problems and determine priorities after system function loss or degradation, and the ability to mobilize resources to suggest solutions.

In the present disclosure, the degradation in functionality is calculated in a damage index-based seismic performance assessment unit 400. The damage index-based seismic performance assessment unit 400 is provided to calculate seismic performance based on an extended damage index by considering the reduction in elongation performance of rebar when compared to the conventional damage index calculated through a nonlinear finite element analysis program and newly establishing an analysis technique and model, and to predict the seismic performance based on the extended damage index.

In addition, the recovery time determined by the rapidity due to the redundancy and resourcefulness of the system is calculated by a disaster/hazard resilience management unit 300, and the resilience loss is calculated by the area of the resilience triangle illustrated in FIG. 6A and may be calculated by a correlation definition module 510.

In this way, the system for assessing seismic resilience of deteriorated railway infrastructure according to an embodiment of the present disclosure is to assess the seismic resilience of the deteriorated railway infrastructure by reflecting the change in disaster safety paradigm of the new resilience concept.

Therefore, as illustrated in FIG. 7A, the seismic performance assessment technique using the damage index is applied. For example, as given in the table of FIG. 7B, the seismic performance assessment technique may be extended to the seismic performance assessment technique using the damage index.

Specifically, the damage index is directly calculated for each analysis step using a strain at a Gaussian integral point calculated in the nonlinear finite element analysis.

For example, the damage index is calculated based on a failure criterion by an ultimate strain of rebar and concrete. In this case, a damage state is determined by one or more limit states and a performance level is specified.

In addition, as illustrated in the table in FIG. 7C, the damage index is calculated as a compressive damage index (DI_{compressive}) and tensile damage index (DIₜₑₙₛᵢₗₑ), respectively, by the failure criterion based on the ultimate strain of the concrete and rebar obtained by the nonlinear finite element analysis.

In this case, the failure criterion may be largely divided into the compressive failure and shear failure of concrete, and the tensile failure of rebar, and the damage index corresponding to the strain of each analysis step may be calculated.

For example, referring to FIG. 7B, a damage index of 0.0 indicates no damage and a damage index of 1.0 indicates failure. A damage index of 0.75 indicates a time point of failure. In addition, a damage index of 0.1 indicates that the rebar has not yet yielded, and indicates a fully functional level with only slight development of flexural cracks. A damage index of 0.4 indicates a functional performance level when the yielding of the rebar occurs and the flexural cracks or shear cracks have developed significantly, resulting in concrete cover spalling. In addition, a damage index of 0.75 indicates a collapse prevention level when fracture of the rebar has begun.

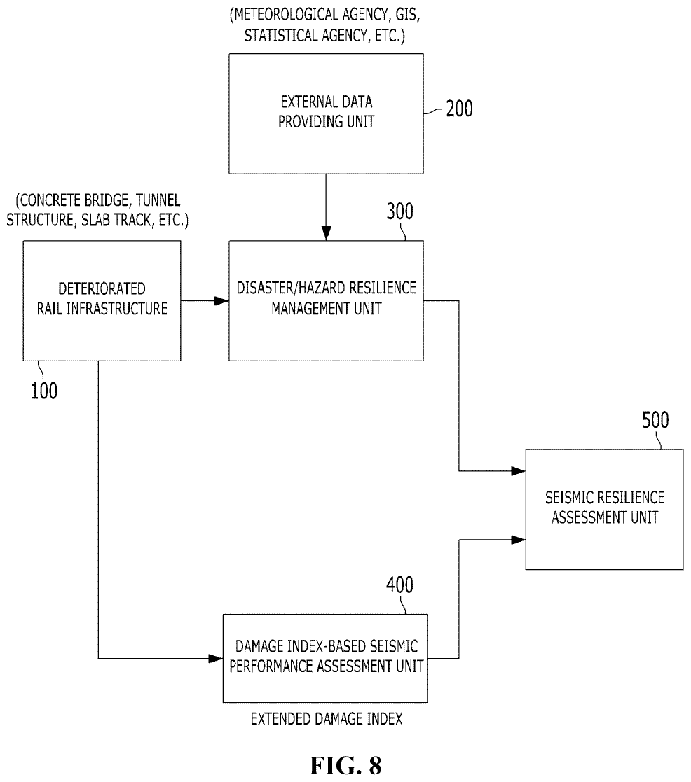

Meanwhile, FIG. 8 is a schematic configuration diagram of the system for assessing seismic resilience of deteriorated railway infrastructure according to an embodiment of the present disclosure.

Referring to FIG. 8, the system for assessing seismic resilience of deteriorated railway infrastructure according to an embodiment of the present disclosure includes the disaster/hazard resilience management unit 300, the damage index-based seismic performance assessment unit 400, and the seismic resilience assessment unit 500. In addition, the system for assessing seismic resilience of deteriorated railway infrastructure according to an embodiment of the present disclosure may include an external data providing unit 200, but is not limited only to including the external data providing data 200. In addition, the system for assessing seismic resilience of deteriorated railway infrastructure according to an embodiment of the present disclosure may optionally include the deteriorated railway infrastructure 100 as needed, but is not limited only to including the deteriorated railway infrastructure 100.

The deteriorated railway infrastructure 100 is a seismic resilience assessment target, and the resilience according to the disaster safety is quantified, and the seismic performance is assessed based on the damage index.

Here, the deteriorated railway infrastructure 100 may be a concrete bridge, a tunnel structure, or a concrete slab track, but is not limited thereto.

The external data providing unit 200 provides external data for the deteriorated railway infrastructure 100. For example, the external data providing unit 200 may include, but is not limited to, a meteorological agency, a construction information provider, a geographic information system, a statistical agency, and an administrative district government office, and provides data required in the system for assessing seismic resilience of deteriorated railway infrastructure according to an embodiment of the present disclosure.

The disaster/hazard resilience management unit 300 collects the external data from the external data providing unit 200 to calculate the resilience, performs the resilience assessment by urban regeneration in response to a degree of aging of the railway infrastructure 100, and assesses recovery activities of the urban network.

The damage index-based seismic performance assessment unit 400 calculates the damage index to assess the seismic performance for the railway infrastructure 100.

The seismic resilience assessment unit 500 defines the correlation between the damage index-based seismic performance and the resilience of the urban network, calculates the resilience quantification for detailed facilities of the urban network, and assesses the seismic resilience of the deteriorated railway infrastructure 100 by linking the seismic resilience with the calculated seismic performance value.

For reference, the correlation may be defined (constructed) through various methods that are obvious to those skilled in the art, such as artificial neural networks, trend lines, formulas, and lookup tables.

Accordingly, the seismic performance of the damage index-based railway infrastructure 100 may be assessed in response to a resilience quantization calculation value from an urban network perspective by the disaster/hazard resilience management unit 300, and the seismic resilience of the urban network may be assessed.

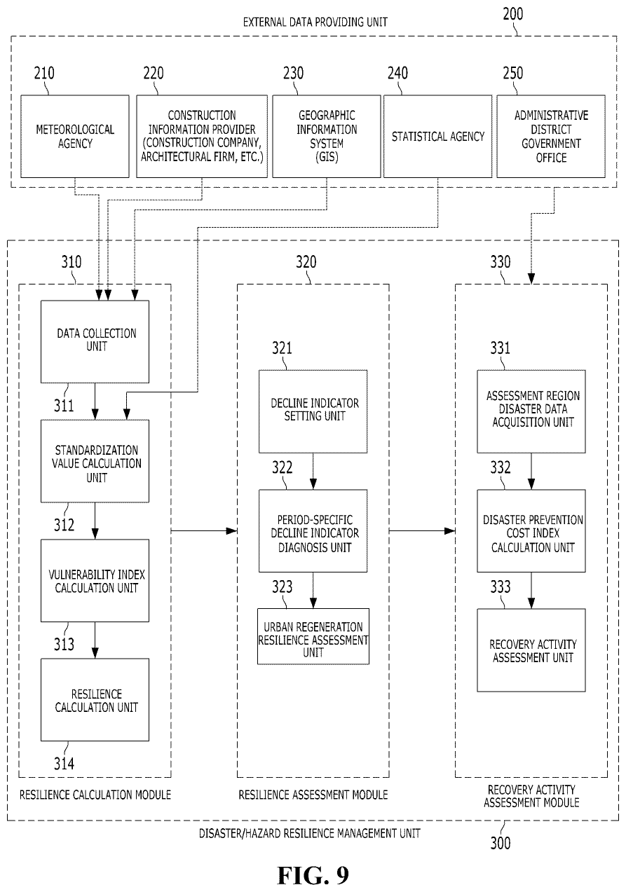

Meanwhile, FIG. 9 is a specific configuration diagram of an external data providing unit and a disaster/hazard resilience management unit in the system for assessing seismic resilience of deteriorated railway infrastructure according to an embodiment of the present disclosure.

Referring to FIG. 9, in the system for assessing seismic resilience of deteriorated railway infrastructure according to an embodiment of the present disclosure, the external data providing unit 200 may include, but is not limited to, a meteorological agency 210, a construction information provider 220, a geographic information system (GIS) 230, a statistical office 240, and an administrative district government office 250.

The meteorological agency 210 provides climate change data on rainfall, wind speed, and snowfall values for a site where the railway infrastructure 100 is constructed.

The construction information provider 220 provides construction information including specification information for the railway infrastructure 100. In this case, the construction information provider 220 may be a construction company or a design office, but is not limited thereto.

The geographic information system 230 provides spatial coordinate information on a location of the railway infrastructure 100.

The statistical office 240 provides population/residential/industrial-based statistics of the administrative district where the railway infrastructure 100 is constructed.

The administrative district government office 250 provides disaster data on the assessment region within the administrative district where the railway infrastructure 100 is constructed.

In addition, referring back to FIG. 9, the disaster/hazard resilience management unit 300 in the system for assessing seismic resilience of deteriorated railway infrastructure according to an embodiment of the present disclosure includes a resilience calculation module 310, a resilience assessment module 320, and a recovery activity assessment module 330.

The resilience calculation module 310 calculates a standardized value through the climate change data, the construction information and GIS data, and the population/residential/industrial-based statistics, calculates a vulnerability index of the administrative district, and calculates resilience based on the capacity index.

Specifically, the resilience calculation module 310 includes a data collection unit 311, a standardization value calculation unit 312, a vulnerability index calculation unit 313, and a resilience calculation unit 314.

The data collection unit 311 collects various data including the climate change data, the construction information and GIS data, and the population/residential/industrial-based statistics from the external data providing unit 200.

The standardization value calculation unit 312 calculates a standardization value through the climate change data, the construction information and GIS data, and the population/residential/industrial-based statistics.

The vulnerability index calculation unit 313 calculates a vulnerability index of an administrative district.

The resilience calculation unit 314 calculates a capacity index based on the vulnerability index and calculates resilience corresponding to the capacity index.

Referring back to FIG. 9, the resilience assessment module 320 sets multiple decline indicators that may assess the decline degree of each assessment region, and diagnoses a period-specific decline degree indicating the degree of aging by calculating the change rate over time for each decline indicator value stored at regular periods, thereby assessing the potential by urban regeneration.

Specifically, the resilience assessment module 320 includes a decline indicator setting unit 321, a period-specific decline indicator diagnosis unit 322, and an urban regeneration resilience assessment unit 323.

The decline indicator setting unit 321 sets multiple decline indicators to objectively assess the aging which is the decline degree of each assessment region within an administrative district.

The period-specific decline indicator diagnosis unit 322 calculates the change rate over time for each decline indicator value stored at regular periods, and diagnoses the period-specific decline degree indicating the degree of aging.

The urban regeneration resilience assessment unit 323 assesses the resilience as the potential by the urban regeneration in response to the period-specific decline degree.

Referring back to FIG. 9, the recovery activity assessment module 330 obtains the disaster data for each assessment region, calculates a disaster prevention cost index of an assessment region using the disaster data, and assesses the recovery activities by observing the temporal trend of the disaster prevention cost index between the assessment regions.

Specifically, the recovery activity assessment module 330 includes an assessment region disaster data acquisition unit 331, a disaster prevention cost index calculation unit 332, and a recovery activity assessment unit 333.

The assessment region disaster data acquisition unit 331 acquires disaster data on the assessment region within the administrative region from the administrative district government office 250.

The disaster prevention cost index calculation unit 332 uses the disaster data to calculate the disaster prevention cost index for the assessment region. For reference, the disaster prevention cost index may be understood as an index that quantifies the cost level required to secure disaster response capability (disaster prevention capability) of the assessment region.

The recovery activity assessment unit 333 quantitatively compares the disaster prevention capability between the assessment regions according to the disaster prevention cost index, helps in decision-making on the distribution of the disaster prevention resources for disaster recovery, and assesses the efficiency of the disaster recovery activities by observing the temporal trend of the disaster prevention cost index. For example, the case where the disaster prevention cost index decreases relatively quickly over time in a specific assessment region compared to other assessment regions may mean that the specific assessment region is a region where effective recovery is achieved at a relatively low cost. In other words, the disaster prevention cost index may be assessed that the efficiency of the disaster recovery activities in the specific assessment region is high.

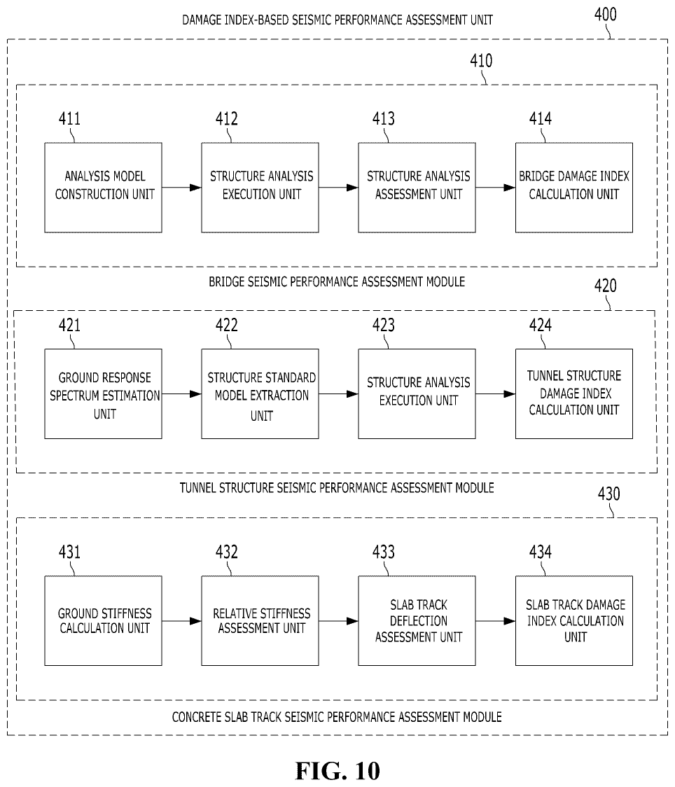

Meanwhile, FIG. 10 is a specific configuration diagram of a damage index-based seismic performance assessment unit in the system for assessing seismic resilience of deteriorated railway infrastructure according to an embodiment of the present disclosure.

Referring to FIG. 10, in the system for assessing seismic resilience of deteriorated railway infrastructure according to an embodiment of the present disclosure, the damage index-based seismic performance assessment unit 400 includes a bridge seismic performance assessment module 410, a tunnel structure seismic performance assessment module 420, and a concrete slab track seismic performance assessment module 430.

The bridge seismic performance assessment module 410 assesses the seismic performance of a concrete bridge with the damage index reflected according to the finite element analysis method when the railway infrastructure is a bridge.

The tunnel structure seismic performance assessment module 420 assesses seismic performance of a tunnel structure with the damage index reflected by extracting a ground response spectrum when the railway infrastructure is the tunnel structure.

The concrete slab track seismic performance assessment module 430 assesses the seismic performance of the concrete slab track with the damage index reflected according to the possibility of deflection of the concrete slab track when the railway infrastructure is the concrete slab track.

Specifically, the bridge seismic performance assessment module 410 includes an analysis model construction unit 411, a structure analysis execution unit 412, a structure analysis assessment unit 413, and a bridge damage index calculation unit 414.

The analysis model construction unit 411 analyzes the structure of the bridge according to the finite element analysis method when the railway infrastructure 100 is the concrete bridge to construct the analysis model, and constructs the analysis model by combining node data, material data, cross-section data, element data, boundary condition data, and load condition data indicating a three-dimensional spatial position.

The structure analysis execution unit 412 converts a load applied to the concrete bridge into a finite element analysis node load, combines the load, and performs the structure analysis using the load.

The structure analysis assessment unit 413 assesses the state according to the structure analysis results considering environmental factors.

The bridge damage index calculation unit 414 obtains vibration information, specification information, and safety information of a bridge structure, and calculates the damage index, which is structure damage information, by formulating a degree of damage according to the structural characteristics of individual bridge structures based on the vibration information, the specification information, and the safety information by using maximum displacement and limit value information.

For example, the damage index-based seismic performance assessment unit 400 may expand the damage index by considering the reduction in elongation performance of rebar, as described below, when the deteriorated railway infrastructure 100 is the concrete bridge.

In addition, referring back to FIG. 10, the tunnel structure seismic performance assessment module 420 is composed of a ground response spectrum estimation unit 421, a structure standard model extraction unit 422, a structure analysis execution unit 423, and a tunnel structure damage index calculation unit 424.

The ground response spectrum estimation unit 421 estimates a response spectrum from earthquake acceleration time history data observed at a plurality of observation points when the railway infrastructure 100 is the tunnel structure.

The structure standard model extraction unit 422 estimates the ground response spectrum at the tunnel structure location using the distance between the observation point and the tunnel structure, and extracts a structure standard model corresponding to the tunnel structure from the database.

The structure analysis execution unit 423 reflects the ground response spectrum to the extracted structure standard model and performs the tunnel structure analysis by comparing the distortion degree and the selected seismic criterion.

The tunnel structure damage index calculation unit 424 calculates a tunnel structure damage index corresponding to the tunnel structure damage as an analysis result of the structure analysis execution unit 423.

In addition, referring back to FIG. 10, the concrete slab track seismic performance assessment module 430 includes a ground stiffness calculation unit 431, a relative stiffness assessment unit 432, a slab track deflection assessment unit 433, and a slab track damage index calculation unit 434.

The ground stiffness calculation unit 431 calculates stiffness characteristic values for each section using a shear wave velocity of the ground when the railway infrastructure 100 is the concrete slab track.

The relative stiffness assessment unit 432 determines the relative stiffness of the concrete slab and the underlying ground using the calculated stiffness characteristic values.

The slab track deflection assessment unit 433 quantitatively assesses the possibility of deflection of the concrete slab track for a lower support layer.

The slab track damage index calculation unit 434 calculates a slab track damage index corresponding to the slab track damage as the assessment result of the slab track deflection assessment unit 433.

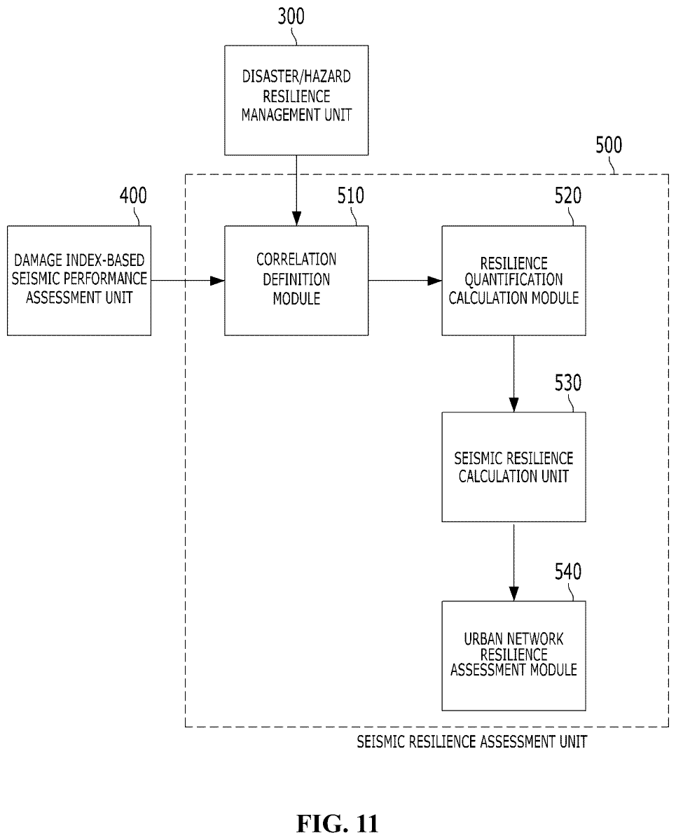

Meanwhile, FIG. 11 is a specific configuration diagram of a seismic resilience assessment unit in the system for assessing seismic resilience of deteriorated railway infrastructure according to an embodiment of the present disclosure.

Referring to FIG. 11, the seismic resilience assessment unit 500 in the system for assessing seismic resilience of deteriorated railway infrastructure according to an embodiment of the present disclosure includes a correlation definition module 510, a resilience quantification calculation module 520, and a seismic resilience calculation unit 530. In addition, the seismic resilience assessment unit 500 may include an urban network resilience assessment module 540.

The correlation definition module 510 defines the correlation between the seismic performance value of the deteriorated railway infrastructure 100 and the resilience of the urban network calculated by the disaster/hazard resilience management unit 300 according to the damage index calculated by the damage index-based seismic performance assessment unit 400.

The resilience quantification calculation module 520 quantifies and calculates the resilience of each detailed facility of the urban network based on the defined correlation.

The seismic resilience calculation unit 530 calculates the seismic resilience value of the urban network by linking the calculated quantification resilience with the seismic performance value of the deteriorated railway infrastructure 100.

The urban network resilience assessment module 540 may assess the resilience of the entire urban network together with the seismic performance and resilience of the deteriorated railway infrastructure 100 so that the comprehensive calculation value for resilience including a resilience amount, a resilience speed, and a resilience cost of the entire urban network may be derived.

As a result, according to an embodiment of the present disclosure, in the railway infrastructure such as the deteriorated concrete bridges, the tunnel structures, the concrete slab tracks, etc., it is possible to assess the seismic resilience of the railway infrastructure by quantifying the resilience according to the disaster safety by reflecting the resilience concept of the urban network type, and extending to the damage index-based seismic performance assessment according to the quantified resilience.

In addition, by calculating the reliable damage index, it is possible to define the correlation between the seismic performance value of the deteriorated railway infrastructure and the resilience of the urban network, and by quantifying and calculating the resilience of the detailed facilities of the urban network and by linking the quantified and calculated resilience with the seismic performance value of the railway infrastructure, it is possible to quickly calculate the final seismic resilience of the urban network.

In addition, by calculating the individual resilience of the aged railway infrastructure by linking the individual resilience with the seismic performance value calculated based on the damage index, and at the same time, by deriving comprehensive calculation values for resilience such as the resilience amount, resilience speed, and resilience cost of the entire urban network, it is possible to easily assess the resilience of the entire urban network as well as the seismic performance/resilience of the aged railway infrastructure.

### [Method for Assessing Seismic Resilience of Deteriorated Railway Infrastructure]

FIG. 12 is a flowchart illustrating a method for assessing seismic resilience of deteriorated railway infrastructure according to an embodiment of the present disclosure.

Referring to FIG. 12, in the method for assessing seismic resilience of the deteriorated railway infrastructure according to an embodiment of the present disclosure, first, the disaster/hazard resilience management unit 300 collects the external data and calculates the resilience for the deteriorated railway infrastructure 100 that is the target of the seismic resilience assessment (S110).

Here, the deteriorated railway infrastructure 100 may be the concrete bridge, the tunnel structure, or the concrete slab track.

Next, the disaster/hazard resilience management unit 300 performs the resilience assessment by urban regeneration in response to the degree of aging of the railway infrastructure 100 (S120).

Next, the disaster/hazard resilience management unit 300 assesses the recovery activities of the urban network (S130).

Specifically, the disaster/hazard resilience management unit 300 may include: the resilience calculation module 310 that calculates the standardized values using the climate change data, the construction information and GIS data, and the population/residential/industrial-based statistics, calculates the vulnerability index of the administrative district, and calculates the resilience based on the capacity index; the resilience assessment module 320 that sets multiple decline indicators that assess the decline degree of each assessment region, diagnoses the period-specific decline degree that indicates the degree of aging by calculating the change rate over time for each decline indicator value stored at regular periods, and assesses the potential by the urban regeneration; the recovery activity assessment module 330 that obtains the disaster data for each assessment region, calculates the disaster prevention cost index of the assessment region using the disaster data, and assesses the recovery activities by observing the temporal trend of the disaster prevention cost index between the assessment regions.

Next, the damage index-based seismic performance assessment unit 400 assesses the seismic performance of the railway infrastructure 100 according to the extended damage index (S140).

Specifically, the damage index-based seismic performance assessment unit 400 may include: the bridge seismic performance assessment module 410 that assesses the seismic performance of the concrete bridge with the damage index reflected according to the finite element analysis method, when the railway infrastructure is the concrete bridge; the tunnel structure seismic performance assessment module 420 that assesses the seismic performance of the tunnel structure with the damage index reflected by extracting the ground response spectrum, when the railway infrastructure is the tunnel structure; and the concrete slab track seismic performance assessment module 430 that assesses the seismic performance of the concrete slab track with the damage index reflected according to the possibility of deflection of the concrete slab track, when the railway infrastructure is the concrete slab track.

Next, the seismic resilience assessment unit 500 defines the correlation between the damage index-based seismic performance value and the resilience of the urban network (S150).

Next, the seismic resilience assessment unit 500 quantifies and calculates the resilience of detailed facilities of the urban network (S160).

Next, the seismic resilience assessment unit 500 calculates the seismic resilience of the deteriorated railway infrastructure 100 by linking the seismic resilience with the calculated seismic performance value (S170).

Specifically, the seismic resilience assessment unit 500 may include: the correlation definition module 510 that defines the correlation between the seismic performance value of the deteriorated railway infrastructure 100 and the resilience of the urban network calculated by the disaster/hazard resilience management unit 300 according to the damage index calculated by the damage index-based seismic performance assessment unit 400; the resilience quantification calculation module 520 that quantifies and calculates the resilience of each detailed facility of the urban network based on the defined correlation; and the seismic resilience calculation unit 530 that calculates a seismic resilience value of the urban network by linking the quantified and calculated resilience with the seismic performance value of the deteriorated railway infrastructure 100.

In addition, the seismic resilience assessment unit 500 derives the comprehensive calculation value for resilience including the resilience amount, the resilience speed, and the resilience cost of the entire urban network to assess the resilience of the entire urban network (S180).

Accordingly, according to the method for assessing seismic resilience of the deteriorated railway infrastructure according to an embodiment of the present disclosure, the seismic performance of the damage index-based railway infrastructure 100 may be assessed in response to the resilience quantification calculation value from the urban network perspective by the disaster/hazard resilience management unit 300.

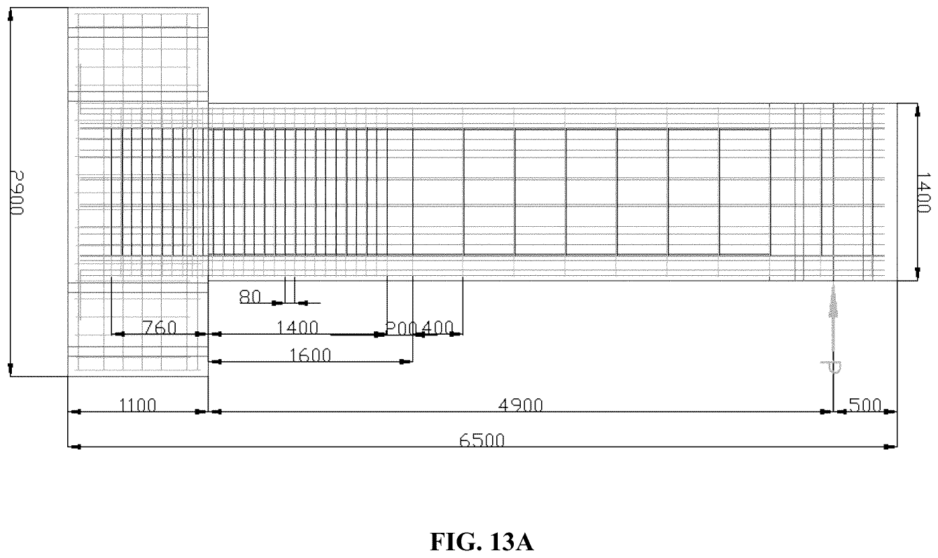

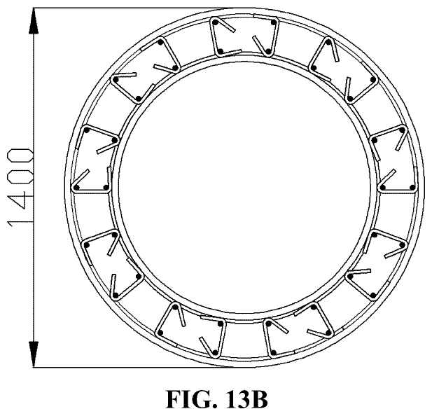

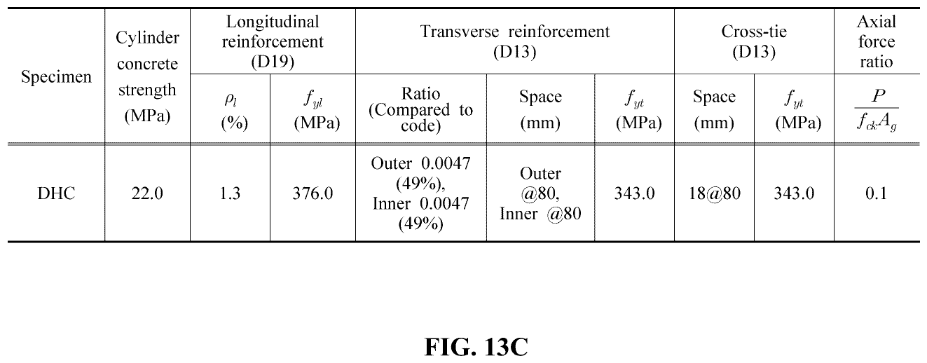

Hereinafter, in the system for assessing seismic resilience of deteriorated railway infrastructure according to an embodiment of the present disclosure, when the deteriorated railway infrastructure is the concrete bridge, the damage index seismic performance assessment for a hollow reinforced concrete pier test specimen will be specifically described with reference to FIGS. 13 to 19.

### Experimental Example

FIGS. 13A and 13B are diagrams illustrating a hollow reinforced concrete pier test specimen when the deteriorated railway infrastructure is the concrete bridge, in which FIG. 13A is a side view and FIG. 13B is a plan view. In addition, FIG. 13C is a diagram in a table form illustrating the material properties of the hollow reinforced concrete pier test specimen illustrated in FIGS. 13A and 13B, and a test specimen was named DHC.

Here, an outer diameter of the hollow reinforced concrete pier test specimen was 1,400 mm, an inner diameter was 980 mm, and a hollow dimension ratio (inner diameter/outer diameter) was 0.70. In addition, a pier height was 4,900 mm, and a shape ratio was 3.5, which induced flexural failure behavior.

As illustrated in FIGS. 13A and 13B, the hollow reinforced concrete pier test specimen was loaded with a constant axial force corresponding to 10% of axial strength of a pier cross-section, and a transverse load was applied using a 3,500 kN actuator to increase a drift ratio from 0.25%, 0.50%, and 1.00% to 5.00%, and repeated loading was performed by 2 cycles.

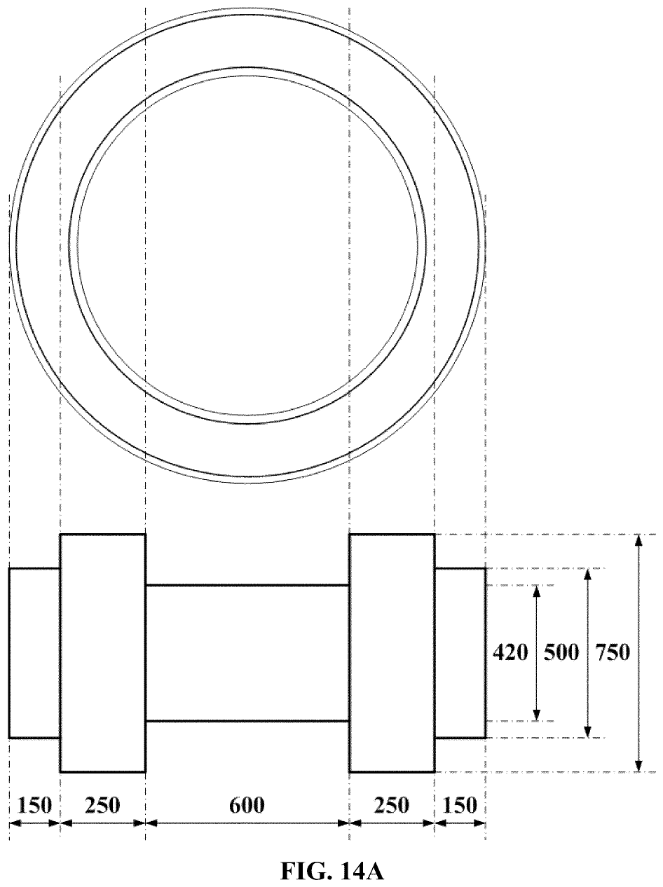

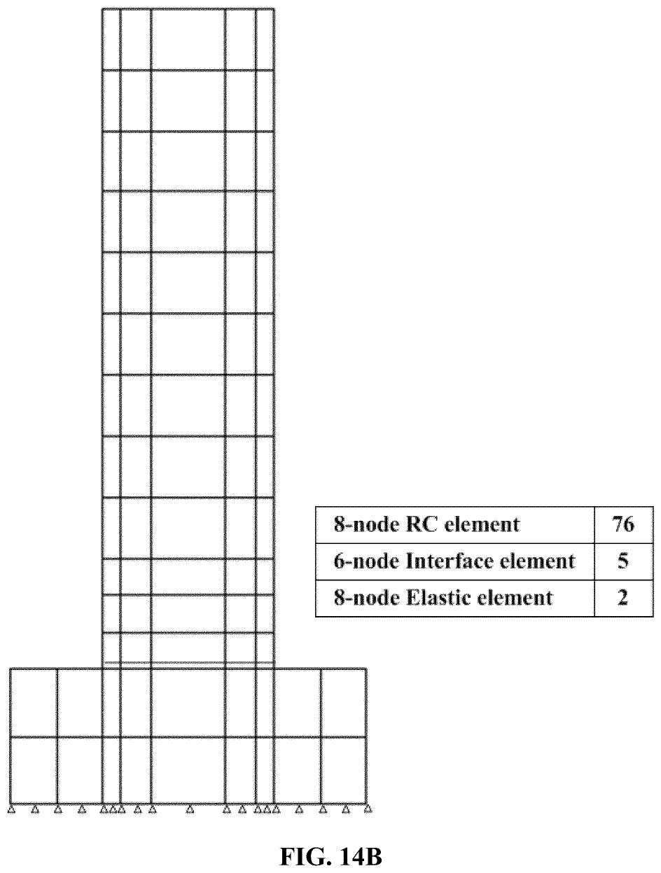

FIGS. 14A and 14B are diagrams illustrating the finite element model when the deteriorated railway infrastructure is the concrete bridge, in which FIG. 14A illustrates an equivalent converted section, and FIG. 14B illustrates a plane stress element, respectively.

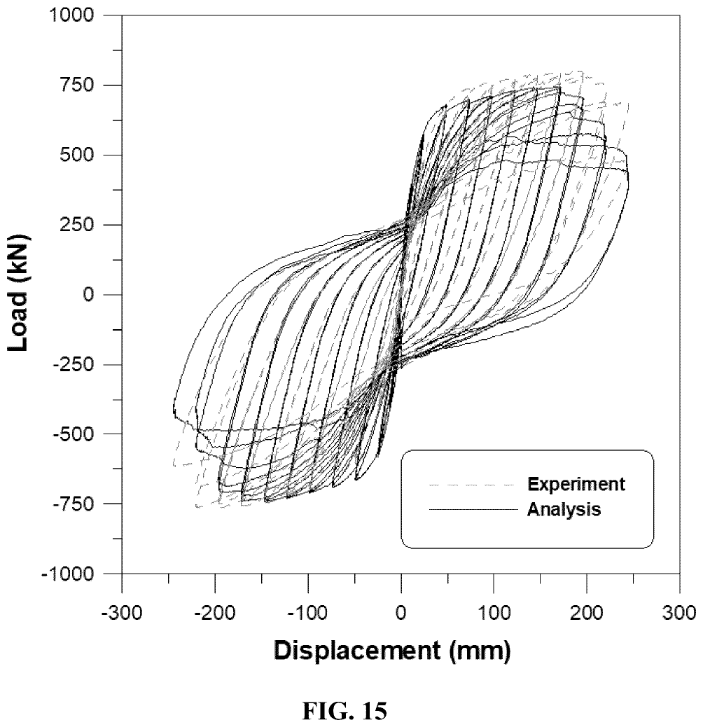

FIG. 15 is a diagram illustrating a load-displacement curve as an experimental and analysis result to which the finite element model illustrated in FIGS. 14A and 14B is applied.

As illustrated in FIGS. 14A and 14B, nonlinear finite element analysis was performed by dividing elements, and accordingly, as illustrated in FIG. 15, it may be seen that a maximum load, a hysteresis curve, and post-failure behavior are well matched with the experimental results in the load-displacement relationship of the nonlinear finite element analysis results using the analysis model and the experimental results.

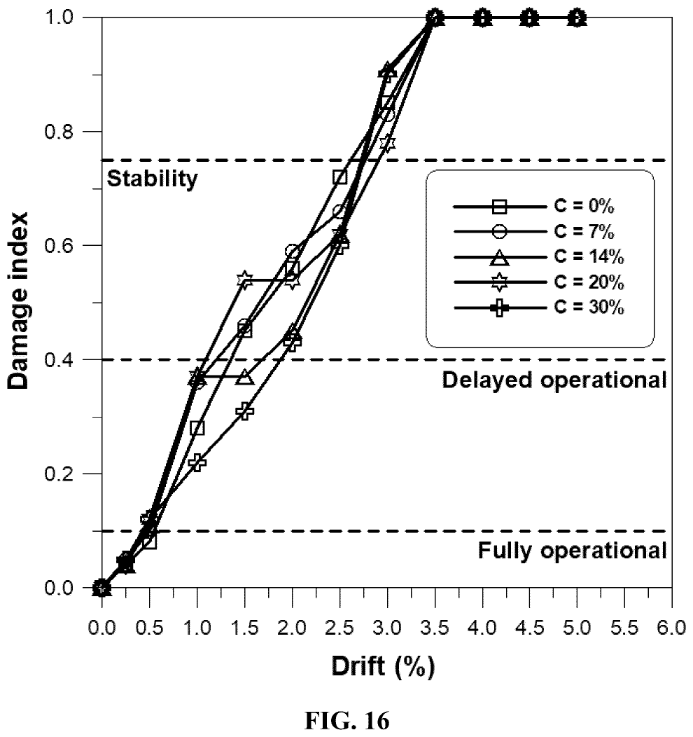

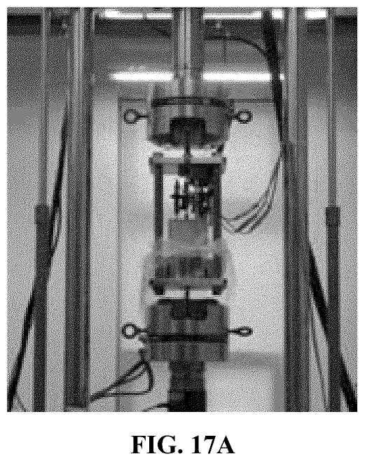

Meanwhile, FIG. 16 is a diagram illustrating the damage index-based seismic performance assessment for the deteriorated hollow reinforced concrete pier test specimen.

In the case of an embodiment of the present disclosure, a corrosion level for the deteriorated hollow reinforced concrete pier test specimen were set to 7%, 14%, 20%, and 30% to perform a parameter study, and the nonlinear deterioration model considered the loss of the cross-sectional area due to the corroded rebar, the decrease in bond strength between the rebar and concrete, and the decrease in ductility, etc.

As illustrated in FIG. 16, the change in the damage index according to the drift was compared and reviewed with the performance level to indicate the seismic performance assessment of the deteriorated hollow reinforced concrete pier test specimen due to aging, etc.

Specifically, in FIG. 16, when checking the damage index values of the analysis results for each loading stage, at drift 0.25%, the corrosion level is 0% and the test specimen is 0.04, the corrosion level is 7% and the test specimen is 0.05, the corrosion level is 14% and the test specimen is 0.04, the corrosion level is 20% and the test specimen is 0.04, and the corrosion level is 30% and the test specimen is 0.05.

In addition, at drift 1.00%, the corrosion level is 0% and the test specimen is 0.28, the corrosion level is 7% and the test specimen is 0.36, the corrosion level is 14% and the test specimen is 0.37, the corrosion level is 20% and the test specimen is 0.37, and the corrosion level 30% and the test specimen is 0.22.

In addition, at drift 2.00%, the corrosion level is 0% and the test specimen is 0.56, the corrosion level is 7% and the test specimen is 0.59, the corrosion level is 14% and the test specimen is 0.45, the corrosion level is 20% and the test specimen is 0.54, and the corrosion level 30% and the test specimen is 0.43.

In addition, at drift 3.00%, the corrosion level is 0% and the test specimen is 0.85, the corrosion level is 7% and the test specimen is 0.83, the corrosion level is 14% and the test specimen is 0.91, the corrosion level is 20% and the test specimen is 0.78, and the corrosion level 30% and the test specimen is 0.90.

Accordingly, in the case of the analysis result that does not consider the reduction in the elongation as illustrated in FIG. 16, it may be seen that some reversal phenomena occur where the corrosion level is large but the damage index is small.

In other words, as the corrosion level of the rebar increases, nominal yield strength and nominal elastic modulus decrease, and the corrosion level is highly correlated with the mechanical properties of the rebar. In addition, it is confirmed that after the tensile test, the fracture starts from local corrosion such as pitting, leading to brittle fracture with low strength and low elongation.

It may be seen that such elongation of the rebar should be considered because it greatly affects the ductility of the RC member.

Therefore, in the case of the system for assessing seismic resilience of deteriorated railway infrastructure according to an embodiment of the present disclosure, the extended damage index-based seismic performance assessment was performed considering the decrease in elongation performance of the deteriorated rebar, which greatly affects the seismic performance.

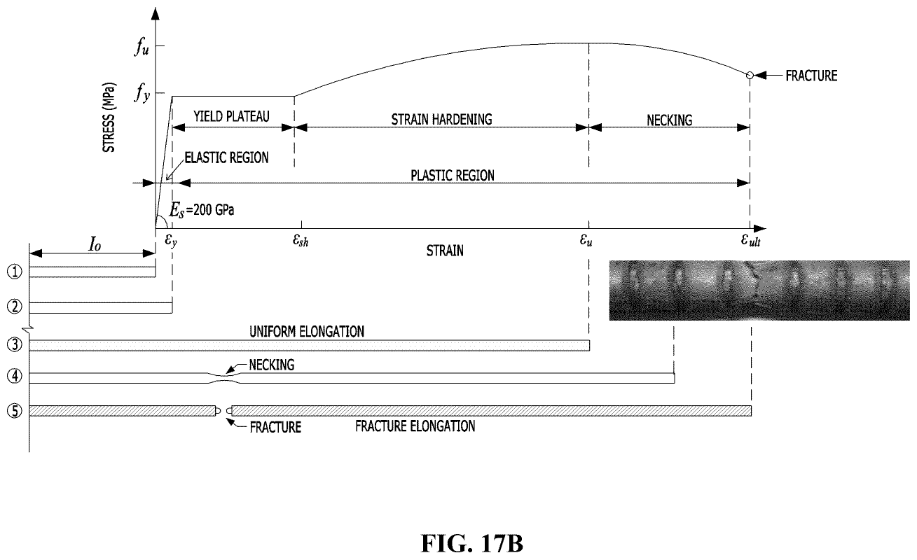

FIG. 17A is a diagram illustrating a monotonic tensile test for rebar, and FIG. 17B is a diagram illustrating representative test data of the monotonic tensile test for the rebar.

Referring to FIGS. 17A and 17B, the elongation may be obtained through a monotonic increasing tensile test on the rebar as illustrated in the following Equation 1.

$$δ = \frac{l - {l}_{0}}{{l}_{0}} \times 100 ( \% ) \qquad [ Equation 1 ]$$

Here, δ denotes the elongation, l₀ denotes a gauge distance, and l denotes a length between gauge points measured after fracture.

In this case, it may be seen that the nominal yield strength and the nominal elastic modulus decrease as the corrosion level of the rebar increases, and the corrosion level shows a very high correlation with the mechanical properties of the rebar.

In addition, it may be confirmed that the fracture starts from the local corrosion and leads to brittle fracture with low strength and low elongation.

Therefore, when measuring the elongation of the deteriorated rebar due to aging, etc., the fracture occurs after necking occurs at a length smaller than a length of a measurement elongation meter after reaching the strength. In addition, the residual maximum elongation of the corroded rebar may be obtained through regression analysis of the experimental data, and the corresponding extended damage index may be obtained as in the following Equations 2 and 3.

That is, the damage index is extended in consideration of the reduction in elongation performance of the rebar, and the extended damage index may be expressed as the compressive damage index (DI_{compressive}) and the tensile damage index (DIₜₑₙₛᵢₗₑ), as in the following Equations 2 and 3.

$${DI}_{compressive} = 1 - {{Φ}_{c} ( \frac{2 {ε}_{cu} - {ε}_{cs}}{2 {ε}_{cu}} )}^{2} \qquad [ Equation 2 ]$$

$${DI}_{tensile} = 1.2 {( \frac{{ε}_{ts}}{2 {Φ}_{r} {Φ}_{e} {ε}_{tu}} )}^{0.67} \qquad [ Equation 3 ]$$

Here, Φ_{c} and Φᵣ denote fatigue parameters for the concrete and rebar, respectively, ε_{cu} and εₜᵤ denotes the failure criteria by the ultimate strain of the concrete and rebar, respectively, ε_{cs} and εₜₛ denote the compressive strain and the tensile strain at the analysis stage, respectively, and Φₑ denotes an elongation reduction coefficient of the deteriorated rebar.

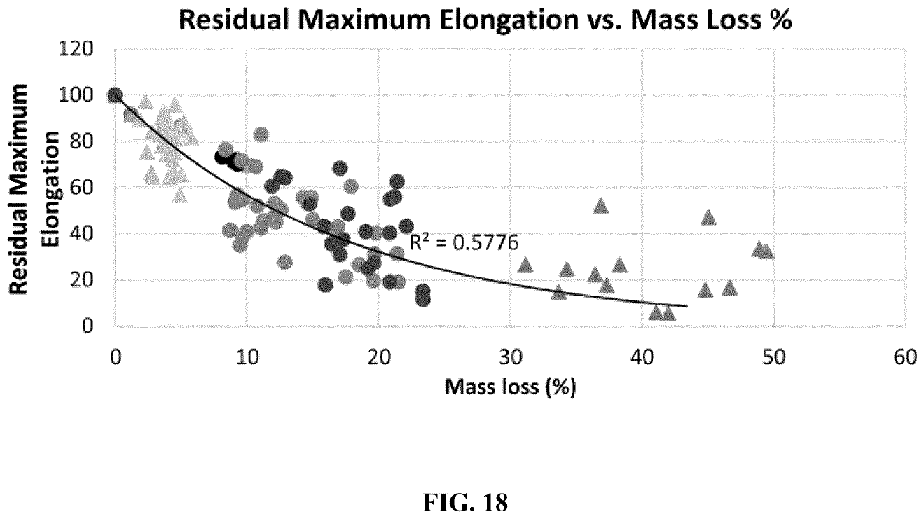

Meanwhile, FIG. 18 is a diagram illustrating an example of the residual maximum elongation compared to mass loss as the experimental result considering the reduction in elongation performance of the deteriorated rebar. For reference, the source of the drawing (graph) illustrated in FIG. 18 is the reference “El-Joukhadar, N., Dameh, F., & Pantazopoulou, S. (2023). Seismic modelling of corroded reinforced concrete columns. Engineering Structures, 275, Article 115251. https://doi.org/10.1016/j.engstruct.2022.115251”, which may be easily understood by referring to the reference document.

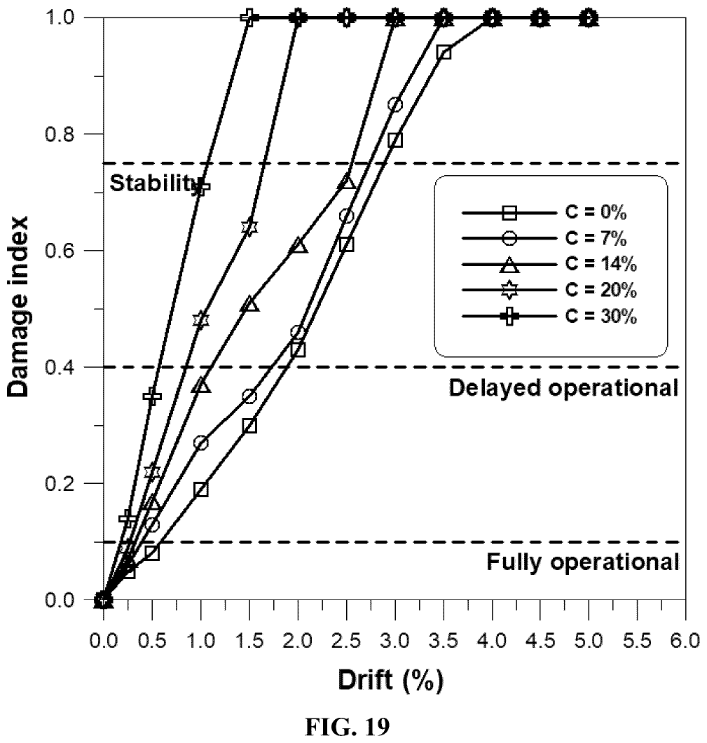

FIG. 19 is a diagram illustrating the damage index-based seismic performance assessment considering the reduction in the elongation of the deteriorated rebar for the hollow reinforced concrete pier test specimen.

As illustrated in FIG. 19, according to the analysis results considering the reduction in elongation performance of the deteriorated rebar due to aging, etc., it may be seen that the reversal phenomenon where the corrosion level is high and the damage index is small is resolved.

In addition, when comparing and examining the change in the damage index according to the drift with the performance level, as illustrated in FIG. 19, it shows the good seismic performance assessment of the deteriorated hollow reinforced concrete pier test specimen due to aging, etc. In this case, when compared with FIG. 16 described above, it may be seen that the behavioral characteristics in which the damage progresses as the corrosion level increases are well expressed.

Specifically, as illustrated in FIG. 19, when checking the damage index values of the analysis results for each loading stage, at drift 0.25%, the corrosion level is 0% and the test specimen is 0.05, the corrosion level is 7% and the test specimen is 0.06, the corrosion level is 14% and the test specimen is 0.07, the corrosion level is 20% and the test specimen is 0.09, and the corrosion level is 30% and the test specimen is 0.14.

In addition, at drift 1.00%, the corrosion level is 0% and the test specimen is 0.19, the corrosion level is 7% and the test specimen is 0.27, the corrosion level is 14% and the test specimen is 0.37, the corrosion level is 20% and the test specimen is 0.48, and the corrosion level is 30% and the test specimen is 0.71.

In addition, at drift 2.00%, the corrosion level is 0% and the test specimen is 0.43, the corrosion level is 7% and the test specimen is 0.46, the corrosion level is 14% and the test specimen is 0.61, the corrosion level is 20% and the test specimen is 1.00, and the corrosion level is 30% and the test specimen is 1.00.

In addition, at drift 3.00%, the corrosion level is 0% and the test specimen is 0.79, the corrosion level is 7% and the test specimen is 0.85, the corrosion level is 14% and the test specimen is 1.00, the corrosion level is 20% and the test specimen is 1.00, and the corrosion level is 30% and the test specimen is 1.00.

In other words, in the case of the analysis result considering the reduction in elongation, it may be confirmed that the reversal phenomenon in which the damage index is small while the corrosion level is large does not appear, and also that the behavioral characteristic in which the damage progresses as the corrosion level increases is well indicated. As described above, the damage index-based seismic performance assessment method has been verified to properly assess the seismic performance of the reinforced concrete piers subjected to the repeated load such as the earthquake load. In this case, by properly assessing the actual behavior and seismic performance of multi-DOF structures such as the reinforced concrete bridges using the nonlinear finite element analysis, it may analytically replace the experimental seismic performance assessment that has time and economic limitations.

In addition, it may be seen that the extended damage index, including the deterioration model and the reduction in elongation of the rebar that governs the behavioral characteristics, may properly assess the seismic performance, making it possible to assess the seismic performance of the deteriorated concrete bridge due to aging, etc.

The above description of the present disclosure is for illustrative purposes, and those skilled in the art to which the present disclosure pertains will understand that it may be easily modified to other specific forms without changing the technical spirit or essential features of the present disclosure. Therefore, it should be understood that the above-mentioned embodiments are exemplary in all aspects but are not limited thereto. For example, each component described as a single type may be implemented in a distributed manner, and similarly, components described as distributed may be implemented in a combined form.

It should be interpreted that the scope of the present disclosure is defined by the following claims rather than the above-mentioned detailed description and all modifications or alterations deduced from the meaning, the scope, and equivalences of the claims are included in the scope of the present disclosure.

### DESCRIPTION OF REFERENCE NUMERALS

100: Deteriorated railway infrastructure (concrete bridge, tunnel structure, slab track, etc.)
200: External data providing unit
210: Meteorological agency
220: Construction information provider (construction company, architectural firm, etc.)
230: Geographic information system (GIS)
240: Statistical office
250: Administrative district government office
300: Disaster/hazard resilience management unit
310: Resilience calculation module
311: Data collection unit
312: Standardization value calculation value
313: Vulnerability index calculation unit
314: Resilience calculation unit
320: Resilience assessment module
321: Decline indicator setting unit
322: Period-specific decline indicator diagnosis unit
323: Urban regeneration resilience assessment unit
330: Recovery activity assessment module
331: Assessment region disaster data acquisition unit
332: Disaster prevention cost index calculation unit
333: Recovery activity assessment unit
400: Damage index-based seismic performance assessment unit
410: Bridge seismic performance assessment module
411: Analysis model construction unit
412: Structure analysis execution unit
413: Structure analysis assessment unit
414: Bridge damage index calculation unit
420: Tunnel structure seismic performance assessment module
421: Ground response spectrum estimation unit
422: Structure standard model extraction unit
423: Structure analysis execution unit
424: Tunnel structure damage index calculation unit
430: Concrete slab track seismic performance assessment module
431: Ground stiffness calculation unit
432: Relative stiffness assessment unit
433: Slab track deflection assessment unit
434: Slab track damage index calculation unit
500: Seismic resilience assessment unit
510: Correlation definition module
520: Resilience quantification calculation module
530: Seismic resilience calculation unit
540: Urban network resilience assessment module

What is claimed is:

1. A system for assessing seismic resilience of deteriorated railway infrastructure, comprising:
a disaster/hazard resilience management unit (300) that collects external data from an external data providing unit (200) providing the external data to the deteriorated railway infrastructure (100), which is a target of seismic resilience assessment, to calculate resilience, performs resilience assessment by urban regeneration in response to a degree of aging of the railway infrastructure (100), and assesses recovery activities of the urban network;
a damage index-based seismic performance assessment unit (400) that calculates a damage index and assesses seismic performance of the railway infrastructure (100); and
a seismic resilience assessment unit (500) that defines a correlation between the damage index-based seismic performance and the resilience of the urban network, calculates resilience quantification for detailed facilities of the urban network, and calculates the seismic resilience of the deteriorated railway infrastructure (100) by linking the calculated seismic resilience with the calculated seismic performance value,
wherein the seismic performance of the damage index-based railway infrastructure (100) is assessed in response to a resilience quantification calculation value from an urban network perspective by the disaster/hazard resilience management unit (300).

2. The system of claim 1, wherein the deteriorated railway infrastructure (100) is selected from among a concrete bridge, a tunnel structure, or a concrete slab track.

3. The system of claim 1, wherein the external data providing unit (200) includes:
a meteorological agency (210) that provides climate change data on rainfall, wind speed, and snowfall values for a site where the railway infrastructure (100) is constructed;
a construction information provider (220), as a construction company or an architectural firm, that provides construction information including specification information for the railway infrastructure (100);
a geographic information system (GIS) (230) that provides spatial coordinate information on a location of the railway infrastructure (100);
a statistical office (240) that provides population/residential/industrial-based statistics of an administrative district where the railway infrastructure 100 is constructed; and
an administrative district government office (250) that provides disaster data on an assessment region within an administrative district where the railway infrastructure (100) is constructed.

4. The system of claim 1, wherein the disaster/hazard resilience management unit (300) includes:
a resilience calculation module (310) that calculates a standardized value through climate change data, construction information and GIS data, and population/residential/industrial-based statistics, calculates a vulnerability index of an administrative district, and calculates the resilience based on a capacity index;
a resilience assessment module (320) that sets multiple decline indicators assessing a decline degree of each assessment region, and diagnoses a period-specific decline degree indicating a degree of aging by calculating a change rate over time for each decline indicator value stored at regular periods to assess a potential by the urban regeneration; and
a recovery activity assessment module (330) that obtains disaster data on the each assessment region, calculates a disaster prevention cost index of the assessment region using the disaster data, and assesses a recovery activity by observing a temporal trend of the disaster prevention cost index between the assessment regions.

5. The system of claim 4, wherein the resilience calculation module (310) includes:
a data collection unit (311) that collects various data from the external data providing unit (200);
a standardization value calculation unit (312) that calculates a standardization value through the climate change data, the construction information and GIS data, and the population/residential/industrial-based statistics;
a vulnerability index calculation unit (313) that calculates the vulnerability index of the administrative district; and
a resilience calculation unit 314 that calculates the capacity index based on the vulnerability index and calculates the resilience corresponding to the capacity index.

6. The system of claim 5, wherein the resilience assessment module (320) includes:
a decline indicator setting unit (321) that sets multiple decline indicators to objectively assess the aging which is the decline degree of the each assessment region within the administrative district;
a period-specific decline indicator diagnosis unit (322) that calculates a change rate over time for each decline indicator value stored at regular periods, and diagnoses the period-specific decline degree indicating the degree of aging; and
an urban regeneration resilience assessment unit (323) that assesses the resilience as a potential by the urban regeneration in response to the period-specific decline degree.

7. The system of claim 6, wherein the recovery activity assessment module (330) includes:
an assessment region disaster data acquisition unit (331) that acquires the disaster data on the assessment region within the administrative region from the administrative district government office (250);
a disaster prevention cost index calculation unit (332) that uses the disaster data to calculate the disaster prevention cost index for the assessment region; and
a recovery activity assessment unit (333) that quantitatively compares disaster prevention capability between the assessment regions according to the disaster prevention cost index, helps in decision-making on a distribution of disaster prevention resources for disaster recovery, and assesses efficiency of a disaster recovery activity by observing the temporal trend of the disaster prevention cost index.

8. The system of claim 2, wherein the damage index-based seismic performance assessment unit (400) includes:
a bridge seismic performance assessment module (410) that assesses the seismic performance of the concrete bridge with the damage index reflected according to a finite element analysis method when the railway infrastructure is a bridge;
a tunnel structure seismic performance assessment module (420) that assesses the seismic performance of the tunnel structure with the damage index reflected by extracting a ground response spectrum when the railway infrastructure is the tunnel structure; and
a concrete slab track seismic performance assessment module (430) that assesses the seismic performance of the concrete slab track with the damage index reflected according to a possibility of deflection of the concrete slab track when the railway infrastructure is the concrete slab track.

9. The system of claim 8, wherein the damage index-based seismic performance assessment unit (400) extends the damage index by considering a reduction in elongation performance of rebar when the deteriorated railway infrastructure (100) is the concrete bridge, the extended damage index is indicated by a compressive damage index and a tensile damage index, the compressive damage by index (DI_{compressive}) is given
$${DI}_{compressive} = 1 - {{Φ}_{c} ( \frac{2 {ε}_{cu} - {ε}_{cs}}{2 {ε}_{cu}} )}^{2} ,$$
and the tensile damage index (DIₜₑₙₛᵢₗₑ) is given by
$${DI}_{tensile} = 1.2 {( \frac{{ε}_{ts}}{2 {Φ}_{r} {Φ}_{e} {ε}_{tu}} )}^{0.67} ,$$
where Φ_{c} and Φᵣ denote fatigue parameters for the concrete and rebar, respectively, ε_{cu} and εₜᵤ denote failure criteria by ultimate strain of the concrete and rebar, respectively, ε_{cs} and εₜₛ denote compressive strain and tensile strain in an analysis stage, respectively, and Φₑ denotes an elongation reduction coefficient of a deteriorated rebar.

10. The system of claim 8, wherein the bridge seismic performance assessment module (410) includes:
an analysis model construction unit (411) that analyzes a structure of the bridge according to the finite element analysis method when the railway infrastructure (100) is the concrete bridge to construct an analysis model, and constructs the analysis model by combining node data, material data, cross-section data, element data, boundary condition data, and load condition data indicating a three-dimensional spatial position;
a structure analysis execution unit (412) that converts a load applied to the concrete bridge into a finite element analysis node load, combines the load, and performs a structure analysis using the load.
a structure analysis assessment unit (413) that assesses a state according to a structure analysis result considering an environmental factor; and
a bridge damage index calculation unit (414) that obtains vibration information, specification information, and safety information of a bridge structure, and calculates the damage index, which is structure damage information, by formulating a degree of damage according to structural characteristics of an individual bridge structure using maximum displacement and limit value information based on the vibration information, the specification information, and the safety information.

11. The system of claim 8, wherein the tunnel structure seismic performance assessment module (420) includes:
a ground response spectrum estimation unit (421) that estimates a response spectrum from earthquake acceleration time history data observed at a plurality of observation points when the railway infrastructure (100) is the tunnel structure;
a structure standard model extraction unit (422) that estimates a ground response spectrum at the tunnel structure location using a distance between the observation point and the tunnel structure, and extracts a structure standard model corresponding to the tunnel structure from a database;
a structure analysis execution unit (423) that reflects the ground response spectrum to the extracted structure standard model to perform tunnel structure analysis by comparing a distortion degree and a selected seismic criterion; and
a tunnel structure damage index calculation unit (424) that calculates a tunnel structure damage index corresponding to a tunnel structure damage as an analysis result of the structure analysis execution unit (423).

12. The system of claim 8, wherein the concrete slab track seismic performance assessment module (430) includes:
a ground stiffness calculation unit (431) that calculates stiffness characteristic values for each section using a shear wave velocity of the ground when the railway infrastructure (100) is the concrete slab track;
a relative stiffness assessment unit (432) that determines a relative stiffness of a concrete slab and an underlying ground using the calculated stiffness characteristic values;
a slab track deflection assessment unit (433) that quantitatively assesses the possibility of deflection of the concrete slab track for a lower support layer; and
a slab track damage index calculation unit (434) that calculates a slab track damage index corresponding to a slab track damage as an assessment result of the slab track deflection assessment unit (433).

13. The system of claim 8, wherein the seismic resilience assessment unit (500) includes:
a correlation definition module (510) that defines a correlation between a seismic performance value of the deteriorated railway infrastructure (100) and the resilience of the urban network calculated by the disaster/hazard resilience management unit (300) according to the damage index calculated by the damage index-based seismic performance assessment unit (400);
a resilience quantification calculation module (520) that quantifies and calculates the resilience of each detailed facility of the urban network based on the defined correlation; and
a seismic resilience calculation unit (530) that calculates a seismic resilience value of the urban network by linking the calculated quantification resilience with the seismic performance value of the deteriorated railway infrastructure (100).

14. The system of claim 13, wherein the seismic resilience assessment unit (500) further includes:
an urban network resilience assessment module (540) that assesses the resilience of the entire urban network together with the seismic performance and resilience of the deteriorated railway infrastructure (100) so that a comprehensive calculation value for the resilience including a resilience amount, a resilience speed, and a resilience cost of the entire urban network may be derived.

15. A method for assessing seismic resilience of deteriorated railway infrastructure, comprising:
a) collecting, by a disaster/hazard resilience management unit (300), external data to calculate resilience for the deteriorated railway infrastructure (100) that is a target of a seismic resilience assessment;
b) performing, by the disaster/hazard resilience management unit (300), resilience assessment by urban regeneration in response to a degree of aging of the railway infrastructure (100);
c) assessing, by the disaster/hazard resilience management unit (300), a recovery activity of an urban network;
d) assessing, by a damage index-based seismic performance assessment unit (400), seismic performance for the railway infrastructure (100) according to an extended damage index;
e) defining, by a seismic resilience assessment unit (500), a correlation between a damage index-based seismic performance value and the resilience of the urban network;
f) calculating, by the seismic resilience assessment unit (500), resilience quantification for a detailed facility of the urban network; and
g) calculating the seismic resilience of the deteriorated railway infrastructure (100) by linking with a seismic performance value calculated by the seismic resilience assessment unit (500),
wherein the seismic performance of the damage index-based railway infrastructure (100) is assessed in response to a resilience quantification calculation value from an urban network perspective by the disaster/hazard resilience management unit (300).

16. The method of claim 15, further comprising:
h) deriving, by the seismic resilience assessment unit (500), a comprehensive calculation value for the resilience including a resilience amount, a resilience speed, and a resilience cost of the entire urban network to assess the resilience of the entire urban network.

17. The method of claim 15, wherein the deteriorated railway infrastructure (100) is selected from a concrete bridge, a tunnel structure, or a concrete slab track.

18. The method of claim 15, wherein the disaster/hazard resilience management unit (300) includes:
a resilience calculation module (310) that calculates a standardized value through climate change data, construction information and GIS data, and population/residential/industrial-based statistics, calculates a vulnerability index of an administrative district, and calculates the resilience based on a capacity index;
a resilience assessment module (320) that sets multiple decline indicators assessing a decline degree of each assessment region, and diagnoses a period-specific decline degree indicating a degree of aging by calculating a change rate over time for each decline indicator value stored at regular periods to assess a potential by the urban regeneration; and
a recovery activity assessment module (330) that obtains disaster data on the each assessment region, calculates a disaster prevention cost index of the assessment region using the disaster data, and assesses a recovery activity by observing a temporal trend of the disaster prevention cost index between the assessment regions.

19. The method of claim 18, wherein the damage index-based seismic performance assessment unit (400) includes:
a bridge seismic performance assessment module (410) that assesses the seismic performance of a concrete bridge with the damage index reflected according to a finite element analysis method when the railway infrastructure is the concrete bridge;
a tunnel structure seismic performance assessment module (420) that assesses the seismic performance of a tunnel structure with the damage index reflected by extracting a ground response spectrum when the railway infrastructure is the tunnel structure; and
a concrete slab track seismic performance assessment module (430) that assesses the seismic performance of a concrete slab track with the damage index reflected according to a possibility of deflection of the concrete slab track when the railway infrastructure is the concrete slab track.

20. The method of claim 19, wherein the seismic resilience assessment unit (500) further includes:
a correlation definition module (510) that defines a correlation between a seismic performance value of the deteriorated railway infrastructure (100) and the resilience of the urban network calculated by the disaster/hazard resilience management unit (300) according to the damage index calculated by the damage index-based seismic performance assessment unit (400);
a resilience quantification calculation module (520) that quantifies and calculates the resilience of each detailed facility of the urban network based on the defined correlation; and
a seismic resilience calculation unit (530) that calculates a seismic resilience value of the urban network by linking the calculated quantification resilience with the seismic performance value of the deteriorated railway infrastructure (100).
